(19) United States
(12) Patent Application Publication
(10) Pub. No.: US 2014/0258020 A1
(43) Pub. Date: Sep. 11, 2014

(54) System for Social Interaction around a Personal Inspirational Message Selectively Hidden in a Display Article

(71) Applicant: Wallace Greene, Snohomish, WA (US)

(72) Inventor: Wallace Greene, Snohomish, WA (US)

(21) Appl. No.: 14/203,354

(22) Filed: Mar. 10, 2014

Related U.S. Application Data
(63) Continuation-in-part of application No. 12/793,624, filed on Jun. 3, 2010.
(60) Provisional application No. 61/784,799, filed on Mar. 14, 2013.

(51) Int. Cl. G06Q 30/06

(52) U.S. Cl. CPC G06Q 30/0621
USPC 705/26.5; 2/69

(57) ABSTRACT

A system for creating and ordering a novel personal inspirational message storage and display article, selectively displaying or sharing the message, and networking with others about stored and shared inspirational messages. The system includes an online subsystem to select, order and pay for a message storage article and to select or create a personal inspirational message for the article. Also included is an article manufacturing subsystem to transfer the selected message to a selected area of the article on the inner side of a flexible material of which the article is made.

### CROSS REFERENCE TO RELATED APPLICATIONS

This application in a continuation-in-part of U.S. patent application Ser. No. 12/793,624 filed Jun. 3, 2010 and further claims priority to U.S. provisional application 61/784,799 filed Mar. 14, 2013.

### TECHNICAL FIELD

This disclosure relates to the field of social and community interaction systems and to methods of displaying personal messages and to articles containing personal messages; more particularly it relates to methods and articles for selectively displaying hidden personal inspirational messages, and to systems of social and community interaction based on the sharing of such messages and on networking about the sharing and the inspiration.

### BACKGROUND OF THE INVENTION

It is known to apply a message to items of clothing such as T-shirts to provide an informational message, an advertising slogan, the logo or name of a sporting team supported by the wearer, an amusing slogan, or the wearer's name. However, such information is generally applied to the front or back side of the shirt, where it is always visible. Thus articles of apparel that statically display words and or graphics that are intended to convey a message are well known. The wearer shows the display to all who view it and lacks selective display control, other than by applying some kind of external screen, such as a cloak or jacket or over-shirt. The message that the wearer wishes to convey in this type of apparel display is limited in its inability to target only specific individuals for viewing the display. A hidden display would provide the wearer with more audience selectivity for the display.

Some garments and other articles are also known that do have some kind of hidden message, that can be used to communicate a message to another person in varying circumstances. Many of the garments of this type have a relatively complicated and conspicuous structure for concealing the message to be hidden, and these structures limit the wearer, at best, to an overt and clumsy display of the message.

There is thus a trend in the garment industry to provide apparel having interactive messages. An interactive message may serve as an advertisement for a particular product and include a trendy fashionable trademark; the interactive message may also serve as a slogan to share personal statements or opinions with others. With most of these articles however, the wearer cannot interact with the statement beyond merely wearing the article.

One known article includes a body portion, an message-bearing surface and a movable trim piece, with the message located on the message-bearing surface. The trim piece is movable between a customarily worn position in which position the trim piece extends over and conceals the message, and a noncustomarily worn position in which the message is exposed for communication.

U.S. Pat. No. 4,710,981 to Sanchez discloses a hidden message display in an article, with a flap pocket having a releasable gripping surface; it requires both obvious and overt action to activate the display, and it has hook and loop fasteners for viewing the display. U.S. Pat. No. 5,794,267 to Wallace discloses a series of exterior panels and flaps to effect a hidden apparel display, and requires an obvious, overt action to open the display. Wallace also uses the hook and loop fastener method to open the display which requires enough force to distort some fabrics, thus adversely impacting the display. Also any method of revealing the display that uses hook and loop fasteners will create a necessarily overt sound. U.S. Pat. No. 4,999,848 to Oney also has an interactive message which is covered by a panel that is constructed to be selectively moved so as to reveal the message. Manufacture of such articles is believed to be relatively complicated and labor intensive.

U.S. Pat. No. 4,991,233 to Hall discloses a hidden display by use of a lanyard which requires a second person to operate a flap, which must be fastened and unfastened. U.S. Pat. No. 5,361,523 to Robinson discloses a garment with a display, but only when the garment is fully opened. The opening is designed for a front, vertical opening garment, and there is only one mode of opening by parting the garment vertically. Another method of gaining attention with a message is to use a torn hole in the garment to display the message behind that hole.

It thus appears that apparel manufacturers want to create designs which communicate, surprise and excite. What is needed is an article with a hidden message display in which the mechanism for revealing or sharing the message is not obvious to a viewer (who is not the wearer), and in which the wearer can selectively control the visibility of the display to others, thereby enabling the wearer to choose the audience (and the time and place) for the hidden display to be revealed.

The examples above suggest a limited range of methods to selectively reveal a message hidden in or on an article: from gadgety, fumbling and clumsy to a bold flash. Collars may be turned up, sleeves may be folded up, pockets and patches and covers may be unzipped, lifted or otherwise opened or removed. Strings may be pulled or simply undone and dropped.

But if the method is also about messages for inspiration and delight, what is needed is to be able to activate each such message in infinitely variable ways, from startling and overt, to furtive and fleeting, to casual or subtle, and thus selectively to startle viewers with elements of surprise and excitement, to tease and intrigue viewers, or to simply inspire, delight and communicate.

There are known ways for people to purchase merchandise with a display that is personalized to their particular requirements. For instance, someone can buy a T-shirt with her own personalized message printed on the front or back. Buying such customized goods however can be time consuming and tedious, typically requiring a visit to a store, a wait in line for assistance, and another wait while the article is being created. And the buyer can only view the final product after it is done. If the message does not come out right, the buyer might have to purchase the product anyway. Online experiences are scarcely better for the most part, and for many of the same reasons.

In addition, there is a conventionally limited range of goods that are even available to be personalized, and limited ways to customize and personalize those goods. People can buy personalized T-shirts, but have only limited choice in what a personalized message can include, and where it can be placed on the article to be customized. What is needed is an online ordering system for personalizing an article with a hidden message, where the system provides for this personalization easily and affordably.

Social networking, blogging, and social and community interaction online are all well known in general. It is known to identify and interact with persons having like tastes and beliefs, and to blog about beliefs and opinions in general.

What is needed is a place or space for inspiration that leads and pulls for personal best, on one's own terms, and according to one's own rules; a place that relates to sports, business, relationships, athletics, and life in general. What is needed is a place promoting and supporting: freedom from artificial standards for personal success; commitment to defining one's own rules and boundaries; and a community of ordinary people who stake a claim to their own “extraordinary”.

What is needed is a new way of defining success; success that isn't limited by artificial standards, by other people, or by cultural norms; where no one cares whether you have freckles or wrinkles, or what color your skin is, or how many degrees you have; where no one counts candles or money, no one speaks the language of “can't” or “shouldn't.”

What is needed is a platform for sharing (member to member, and one to many) with a community that supports an ideology that people are important, that they are strong, and that people are inherently capable of working, aspiring, competing, and achieving for both the individual and the greater good.

What is needed is an online store that offers exceptional products, through which individuals can choose to support community charities, such as by taking a portion of the revenue of every sale, and donating it to selected foundations and nonprofit organizations whose programs and beliefs mirror the above values and principles. What is needed is a store offering ready to wear sportswear and accessories that contain a customer's personal and hidden motivational message, clothing carefully selected to produce and visually communicate the spirit of that message.

What is needed are online platforms (including blogging and news) devoted to claiming one's personal extraordinary, where articles and information about people around the world, in all walks of life, who are living their lives in ways that are meaningful to them, can be found; where in return, one can share thoughts about the answers to questions such as, “How should one compete?” “Where does aspiration come from?” and “Who defines success?”

### DISCLOSURE OF THE INVENTION

This disclosure addresses and provides such a system as well as the desirable articles themselves and the desirable methods of displaying such hidden messages.

What is disclosed are systems and methods for generating and maintaining a space of inspiration that can lead people to their personal best, on their own terms, and according to their own rules. Such inspiration is relative to sports, business, relationships, athletics, and life in general. Such a space promotes and supports freedom from artificial standards for personal success, commitment to defining one's own rules and boundaries; and a community of ordinary people who stake a claim to their own “extraordinary”. Such a space newly defines “success”; success that isn't limited by artificial standards, by other people, or by cultural norms; success that is blind to skin, stature, standing or customs.

A platform is disclosed that supports an ideology that people are important, that they are strong, and that people are inherently capable of working, aspiring, competing, and achieving: for both the individual and the greater good. The platform provides for sharing from member to member, and from one to many with a community.

Also disclosed is an online store that offers exceptional products, through which individuals can choose to support community charities, by taking a part of every sale that generates revenues, and donating to selected foundations and nonprofit organizations whose programs and beliefs mirror these values and principles. The store offers branded, ready to wear sportswear and accessories that contain a customer's personal and hidden motivational message, clothing carefully selected to produce and visually communicate the spirit of that message. Purchase of the personalized branded gear in the store is a way of demonstrating one's individuality and commitment to realizing one's personal success and triumphs on one's own terms. Also disclosed are online platforms devoted to claiming the personal extraordinary. On a platform (for instance a blog platform) can be found articles and information about people around the world, in all walks of life, who are living their lives in ways that are meaningful to them. Members share their thoughts about the answers to questions such as: How should one compete? Where does aspiration come from?Who defines success? Together, members create a community that sets its own boundaries. On the news pages, members suggest newsworthy events and persons who embody these values, and notable achievements in personal success at the level of, and for the benefit of, the community are reported regularly.

Application of the disclosed subject matter to the needs recognized and summarized above is especially beneficial in that the disclosed systems, methods and articles are the only ones that effectively provide practical, affordable and readily available solutions to these needs.

An article is disclosed, typically but not necessarily an article of wear or clothing, or a wearable accessory, that is adapted or configurable to be worn by a first person, also referred to as the wearer, the user, and the like. The article has a user selectable normal mode of wear (also referred to herein as secret message mode or message secret mode, or hidden message or message hiding mode) in which a message printed, screened, woven, sewn, or otherwise attached or applied to an inside or inner surface of the article is hidden from the normal view any second or third persons, also referred to as viewers, audience, others, or the like, in this message secret mode. The article is adapted to start in this normal or message secret mode when donned or worn by the user, and to easily revert automatically to this mode whenever the user or wearer is not otherwise taking or sustaining action to selectably place the article into, or hold the article in, a message sharing mode.

The message sharing mode, in which the hidden message is temporarily, even momentarily, briefly or fleetingly, everted, flashed, shown, shared or displayed to a second person or viewer is advantageously not permanent or lasting, and is desirably only maintained while the user is taking or sustaining action to shift, lift, twitch, raise or temporarily fold or otherwise alter the wear or drape of the article into the message sharing mode. It is desirable that such a message sharing mode not be sustainable in the article without the continued and direct action of the wearer or first person. For example, such action is typically a hand initiated action, such as lifting a hem or rolling a sleeve or pulling up or down some edge or hem of the article. And when the hand relaxed or releases the article drops, unrolls or snaps back into the default or normal wear mode, with the result that the message is once again hidden.

Thus systems that allow for various kinds of folding and material rearrangements (such as hook and loop attachments, pinning or snapping) of a garment into a different configuration that do not require continued manual action by the wearer to sustain the configuration are distinguished.

Alternatively, the hidden message may be everted and displayed only to the wearer, for the wearer's own personal inspiration, motivation, or recollection, rather than to a second person.

The article is generally made of a flexible material such as woven cotton or a synthetic material with similar flexible properties. The article has an inside or inner side facing the first person when the article is being worn, and an outer side facing away from the first person when the article is being worn. The material is advantageously a single layer of material or fabric, though some embodiments may use a double layer of fabric as the flexible material. The disclosed flexible material on which the message is screened or printed is generally not merely a flap (such as any hanging tag-like structure or pocket flap or tab or the like) connected to the article, as it is believed that the usefulness of such structures for the purposes disclosed herein is limited. Similarly, the disclosed material is also generally not merely a fold in the article.

The message is a generally a personal inspirational message, and is desirably disposed on the inside or inner side of the material, the side facing the first person as worn, and is thus hidden from view in the normal wear (message secret) mode. The message is however readily viewable by a second person when the wearer shifts, lifts, twitches, raises or momentarily folds or otherwise alters the wear or drape of the article to the message sharing mode. The message can be any combination of alphanumerical characters and or other graphical elements, such as pictures or drawings.

The article is advantageously, but not necessarily exclusively, one or more of the following: t-shirt, sweat shirt, polo shirt, jacket, sweater, or other upper torso covering attire or garment; or shorts, trousers, athletic, sport or casual attire, or skirt, dress, or other mid to lower torso covering attire, wrap, or garment that has an upper waist band area or hem that can be fixed or expandable; or any hat, or any other cranial covering attire or wrap that has an edge, rim, or bill, or a shoe tongue.

The message is advantageously disposed on the inside of the article by being imprinted or screened or stitched onto an inside surface the material. The message can also be disposed on the material by being permanently attached, or removably connected to the material, such as by being stitched or printed onto a patch and th patch or message add-on piece then either glued or sewn to the material or removably attached with a removable fastening means such as hook-and-loops, snaps, buttons, magnets or the like.

In some embodiments, the message is positioned on an edge or hem or waistband of the article. In some embodiments, the message is printed (relatively) upside down so that the second person may readily read the message when the article is shifted into message sharing mode, while in other embodiments, the message is printed (relatively) rightside up so that the first person wearer may readily read their own message when the article is shifted into message sharing mode.

In some embodiments, the article includes a machine readable data tag, such as an RFID chip or a bar code, and the data tag may be either separate from, or integrated into, the message. This data tag can also alternatively be bar codes, data references, data storage, and/or transmitting elements, all either now known or later developed.

A method of storing, displaying and or sharing an otherwise hidden, selectably sharable, personal message is also disclosed. The method includes the steps of disposing on the inner side of a flexible material of an article configurable to be worn by a first person a personal message so that it is hidden from view on the inner side of the material, and preferably inside the article, in a message secret wear mode. The article is preferably made of the flexible material, and the article and the personal message are desirably made, composed and characterized as described above. Optionally, the message may be selectably disposed within the article in a selected number of locations, such as just above the hem, just inside the waistband, midway up the torso, inside the collar, and the like. Modes of wear, such as message sharing mode, or message secret mode, are also as described above.

Next, the first person selectably shifts the article by lifting, twitching, raising or folding or otherwise altering the wear or drape of the article on the first person to a manually sustained message sharing mode so that the message is displayed to and shared with a second person, but only while the user or first person is taking or sustaining action to shift, lift, twitch, raise or temporarily fold or otherwise alter the wear or drape of the article into the message sharing mode. Such action is desirably brief, temporary, or even in the nature of a ‘flash’; but the action may be sustained for any period of time selected by the wearer, until the wearer chooses to manually release the material of the article so that it drops, unrolls, or otherwise snaps back or returns to it default or original message secret mode. Such action generally does not include any kind of pinning, crimping, buttoning or hook-and-loop attaching, or the like that results in the altered drape of the article being sustained without the use of the wearers hands, or other temporary manual action by the wearer.

In the disclosed methods, the message is desirably disposed and positioned by being imprinted, screened or stitched directly onto the material, or alternatively the message is disposed by being attached, or removably connected to the material. The message may be attached by being stitched or printed onto a patch and the patch then either glued or sewn to the material. Or the message may be removably attached by being stitched or printed onto a patch and the patch then removably attached to the material with a removable fastening means such as hook and loops, snaps, buttons, magnets or the like. In some embodiments, a personal data tag, such as further described herein may also be included in the article, likewise hidden from view in a message secret mode, and either disposed remotely from the personal message or in proximity to it, or integrated into the personal message itself, such that displaying the personal message also displays the personal data tag for scanning or capture.

A method of personal expression by a first person to a second person or group of persons is disclosed. The method generally includes or follows the steps of the method of storing, displaying and sharing described just above, and also advantageously includes steps relating to personal flair. Such personal flair is selectable by the wearer and generally highly individual, and can for example include boldly striking a gesture or pose suitable to the personal message, as a part of the manual action to shift, lift, twitch, raise or fold or otherwise alter the wear or drape of the article into the message sharing mode. The pose or gesture can be combined with other poses or gestures in series, and any pose or gesture can be timed to coincide with the moment of transition from message secret mode to message sharing mode, or it can precede the transition or be deferred to follow after the transition. It can also include flair in the way that the article is manually released to go back into its default shape or message secret mode.

A method of making an article with a personal stored message for selected display to a second person is disclosed. The method includes the step of taking an article that is configurable to be worn by a first person and made of a flexible material with an inner side facing the first person, and an outer side facing away from the first person, and disposing a personal message at a selected location on the inner side of the material. The message is thus stored and generally, by default, hidden until or unless the wearer chooses to alter the drape or shape of the article by manual action to reveal or display the message to selected other persons.

A method of sharing selected personal data by a first person with a selected second person is disclosed. The method includes the step of disposing on an article of wear a personal data tag. The data tag may or may not be an actual flap or tag, and it is optionally and desirably physically incorporated into, or in close proximity to, the personal inspirational message on the inside of the article. Alternate embodiments will have personal data tags that are separate and or separate and distant from the personal inspirational message.

Data tags may be conventional barcodes or RFID chip tags, or any other data storage structure now known or later developed that is adapted to have the stored data visually or electronically scanned by a suitable and compatible device. The personal data tag is (in manner like to the storage and display method above) desirably hidden from view inside the article on an inside surface of the material in normal (message secret) wear mode, but then it is readily scanable by a second person when the first person shifts the article to a data sharing mode (or message sharing mode, when the data tag and personal message are combined or in close proximity). In the method, the first person then dons or wears the article containing the data tag.

A further step of the method includes the first person shifting the article by manually lifting, twitching, raising or folding or otherwise altering the wear or drape of the article on the first person to a manually sustained data sharing mode and inviting the second person to scan or capture the tag (or the data on the tag, such as a personal data code, the code related to data stored elsewhere), thus exposing the personal data tag to the second person for scanning, but only while the first person sustains action to shift, lift, twitch, raise or fold or otherwise alter the wear or drape of the article into the data sharing mode. The invitation can be stylized and for example include or consist of the words “tag me”, or the like. The personal data tag is thus exposed to the second person for scanning or capture of the data on the tag.

Where the capture device is an asynchronous device, the asynchronous device is a digital camera, and the personal data tag is a bar code, the capture device stores for later manipulation and transmission a digital image of the bar code. Then at some later time selected by the second person, the digital image is manipulated and transferred in conventional fashion to communicate the stored personal data tag code to a remote database that holds personal data of the first person (previously selected by the first person) in coded relationship with the personal data tag code. The second person then receives from the remote database the selected personal data of the first person, and optionally stores that personal data in a database of contact information controlled by the second person.

Wherein the personal data tag is an RFID tag, or the like, the capture device is advantageously an RFID scan-enabled device, such as an iPhone or other PDA or phone or like device now known or later developed, the device generally having an on-board database of contact information. The device then communicates (preferably immediately) the personal data tag code to a remote database that has selected personal data of the first person in coded relationship with the personal data tag code and the device then receives back from the remote database the personal data of the first person, and optionally stores it in the on-board database of contact information.

A further step of the method includes the second person scanning the personal data tag with a suitable, scan-enabled device such as a PDA or digital phone. Alternatively, any digital device such as a camera that can take an image of the bar code, or otherwise read the device such as an RFID data tag, for asynchronous manipulation, transmittal, or uploading of the stored data at a later time, may also be used.

Further steps of the method includes the device communicating the scanned personal data tag code with a remote database comprising personal data of the first person in coded relationship with the personal data tag code, and the device receiving from the remote database the personal data of the first person, and storing that personal data in the device's own on-board database of contact information.

A method for creating and ordering a novel personal inspirational message storage article is disclosed. The method includes the step of a customer selecting and ordering through a computer network an article such as a t-shirt or skirt and then selecting or creating a personal inspirational message for customizing the article. The selected personal inspirational message is then incorporated into the selected article. One step of the method includes a computer system receiving an order of the article from the customer, then the customer creating a personal inspirational message either newly, or selecting a personal inspirational message from among previously stored inspirational messages, and then storing on the computer system the selected personal inspirational message as a message data file that contains character information or graphical or image information or both. A further step of the method includes transferring to a selected area of the ordered article the stored message data. The selected area of the article to which the message is transferred is on the inner side of a flexible material of which the article is made. The article is then shipped to the customer.

A method for networking with others about stored and shared inspirational messages is disclosed. The method includes the step of a customer entering, through a computer network, a community portal page on a website operatively residing on a computer connected with the network. A further step of the method includes the customer selectably performing some or all of the following: blogging with other customers about stored and shared inspirational messages, linking to social media, searching for other customers by name, or reviewing other customers' personal inspirational messages. A further step of the method includes the customer selectably responding to other customers about her own stored and shared inspirational messages.

A system is disclosed for creating and ordering a novel personal inspirational message storage article, selectively displaying or sharing the message, and networking with others about stored and shared inspirational messages.

The system includes a customer computer connected to a company computer through a global network for a customer to select, order and pay for a message storage article. The article is advantageously an article that can be worn as a garment, accessory or other wearable article. The article serves not only as clothing but also as a place to store and hide a personal inspirational message which is then selectively shown to others only when the customer desires. This process generally includes order control, message processing and check out modules operably connected with the company computer. The company computer can stand alone or be a part of a network of such company computers or computer and data storage systems, and the disclosed system can be practice by one company or more, who may or may not be legally or commercially related. While ordering the storage article, the customer also selects or creates the personal inspirational message for the article. The message processing and check out modules are advantageously further operably connected to an article manufacturing and shipment system and article manufacturing and shipment system computer. The article manufacturing and shipment system may be a simple apparatus for imprinting pre-made shirts or the like with personal messages, or it may be a complex manufacturing facility, or set of facilities around the globe, for making articles, screening, printing or stitching messages on articles, and preparing completed articles for global shipping, or any intermediate system.

The order control module operatively resides in computer readable memory operatively connected to the company computer for receiving the order of the article from the customer. The message processing module operatively resides in computer readable memory operatively connected to the company computer for selectably creating by the customer the personal inspirational message, and storing the selected personal inspirational message as a message data file containing character information and or image information. The customer may alternatively select a message from among inspirational messages previously stored in operably connected databases, and that selected message is then stored and processed the same as would be a created message.

The check out cart module operatively resides in computer readable memory operatively connected to the company computer for handling payment for and shipping of the ordered article. The article manufacturing system computer is operably connected with the message processing module for transferring the message data file to an image transfer module operatively residing in computer readable memory operably connected with the article manufacturing system and system computer for controlling transfer of the message to a selected area of the article. The article is thus customized with the selected message. The selected area of the article to which the message is transferred is desirably on the inner side of a flexible material of which the article is made, but may additionally be selected as to location on the article, such as on the hem, above the hem, below the collar, below the waistband, and the like.

The shipping is ordered through the check out module by the customer and executed by the shipping system upon completion of the article by the article manufacturing system. The customer then receives the hidden message storage article ordered and selectively displays or shares the hidden personal inspirational message with others by wearing the article and then selectably shifting the article by lifting, twitching, raising or folding or otherwise altering the wear or drape of the article to a manually sustained message sharing mode so that the message is displayed to and shared with a second person, but only while the customer sustains action to shift, lift, twitch, raise or fold or otherwise alter the wear or drape of the article into the message sharing mode.

The system also includes a customer computer (which may be the same customer computer as discussed above, or a different computer) connected for communication through the global network for a customer to enter a community portal page on a website operatively residing on the computer readable memory of a company computer (which may be the same company computer as discussed above, or a different computer) connected with the global network. On this page the customer may selectably blog with other customers about the customer's use of her shared inspirational messages or her observed use of the inspirational messages of others, or link to conventional social media, or search for other customers by name or message, or review other customers' personal inspirational messages or information about the use or sharing of those messages. And in this way, customers and users of personal inspirational messages on message storage articles, can network with each other and the world about what such messages have inspired in themselves and others, and about what such inspiration is accomplishing for themselves and others.

### BRIEF DESCRIPTION OF THE DRAWINGS

FIG. 1 is a schematic illustration of an article in a message sharing mode.

FIG. 2 is a schematic illustration of an article in a normal mode (also Prior Art).

FIG. 3 is a partial schematic cross section on an article on a body.

FIG. 4 is a schematic illustration of a message.

FIG. 5a is a partial schematic cross section on an article on a body.

FIG. 5b is a schematic detail of a message.

FIG. 6 is a screenshot of the disclosed system.

FIG. 7 is a screenshot of the disclosed system.

FIG. 8 is a screenshot of the disclosed system.

FIG. 9 is a screenshot of the disclosed system.

FIG. 10 is a screenshot of the disclosed system.

FIG. 11 is a screenshot of the disclosed system.

FIG. 12 is a screenshot of the disclosed system.

FIG. 13 is a screenshot of the disclosed system.

FIG. 14 is a screenshot of the disclosed system.

FIG. 15 is a screenshot of the disclosed system.

FIG. 16 is a screenshot of the disclosed system.

FIG. 17 is a screenshot of the disclosed system.

FIG. 18 is a screenshot of the disclosed system.

FIG. 19 is a screenshot of the disclosed system.

FIG. 20 is a screenshot of the disclosed system.

FIG. 21 is a screenshot of the disclosed system.

FIG. 22 is a screenshot of the disclosed system.

FIG. 23 is a screenshot of the disclosed system.

FIG. 24 is a screenshot of the disclosed system.

FIG. 25 is a flowchart of a disclosed methodology.

FIG. 26 is a flowchart of a disclosed methodology.

FIG. 27 is a flowchart of a disclosed methodology.

FIG. 28 is a flowchart of a disclosed methodology.

FIG. 29 is a schematic diagram of an aspect of the disclosed system.

FIG. 30 is a schematic diagram of an aspect of the disclosed system.

FIG. 31 is a schematic diagram of an aspect of the disclosed system.

FIG. 32 is a flowchart of a disclosed methodology.

FIGS. 33-59 are screenshots of the disclosed Live it Wear it Share it system.

### DETAILED DESCRIPTION

Turning now to the drawings, the invention will be described in various embodiments by reference to the numerals of the drawing figures wherein like numbers indicate like parts.

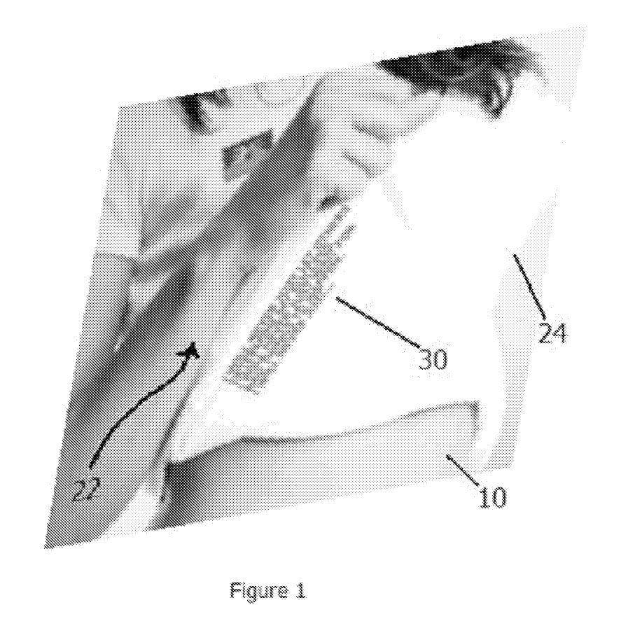

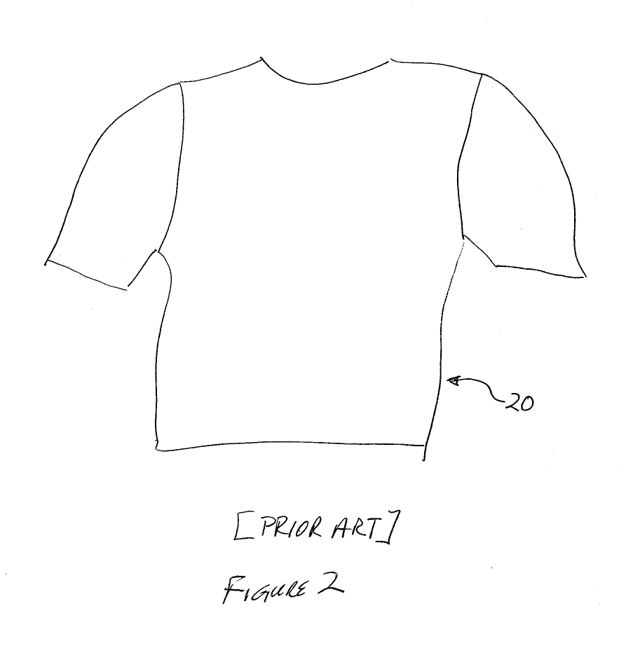

FIGS. 1 through 5 generally illustrate aspects of the disclosed article. FIG. 1 shows a typical article, a t-shirt, in a normal mode of wear 20 by a wearer or first person. No messages are visible; any message present is hidden from the view of second persons. FIG. 2 shows a comparable, though not necessarily identical, article, again a t-shirt, this time in a message sharing mode 22. Article 24 is being worn by wearer 10 who has shifted or altered the wear of article 24 to reveal a previously hidden message 30. The process illustrated is reversible, to once again hide the message or place the message in a hidden position, with the article restored to normal mode 20. The process is selectable and repeatable, at the discretion of wearer 10.

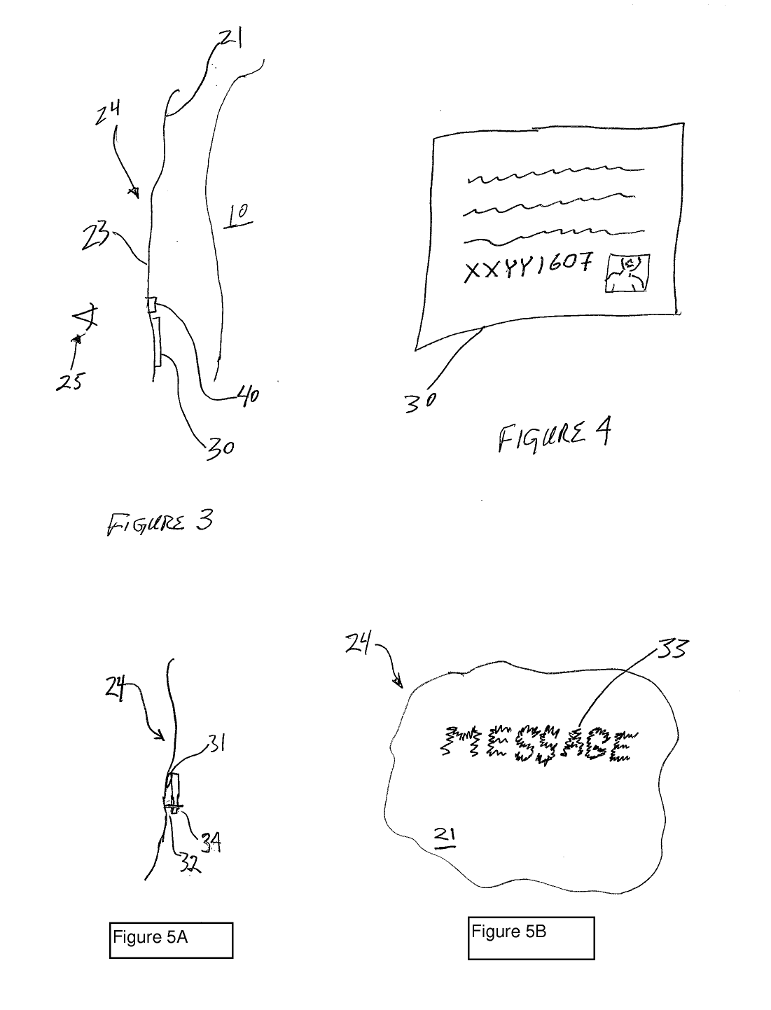

FIG. 3 shows hidden placement of message 30 on an inside surface 21 of article 24, as worn by wearer 10; it also shows hidden placement of optional personal data tag 40 on article 24. Both message 30 and data tag 40 are disposed on the inner surface 21 of article 24 so that from the point of view 25 of another or second person, who sees only the outside surface 23 of article 24, there is no message or data tag on display. Message 30 is shown advantageously placed in a lower area of article 24, so that a part of the lower area of the article may be shifted, ‘flipped’ or otherwise shifted to briefly, selectably and hidably reveal or display the message to a second person or persons.

The position or location of message 30 however is preferably selectable by wearer 10 (at least up until the message is attached to article 24), and is not confined to lower areas of articles. Since a disclosed article may take any of several forms as disclosed herein, the sense of ‘lower’ as compared to ‘upper’, or any other locational adjective, is relative both to the style of article chosen as the vehicle or container for the message, and also to the wearer's preference for how and in what manner the message may be revealed to viewers. Some positions of message 30 in at least some articles will be regarded by at least some viewers as more or less surprising, more or less provocative, more or less playful, etc., than other positions that can be imagined. This variability of positioning, coupled with other stylistic choices by wearer 10 (such as when, with what speed, for how long, with what flair and in front of whom the message is displayed) all contribute to the individualizability of hidden message display in disclosed articles.

FIG. 4 schematically shows message 30, apart from any attachment to article 10. Message 30 may contain any or all of alpha characters, numerals, punctuation or pictorial or figurative or other graphic elements. Message 30 can advantageously be printed or screened directly on inner surface 21 of article 24, or can alternatively be printed, screened, painted, embroidered or otherwise stitched (see FIG. 5b with stitching 33) or otherwise rendered on patch 34 (FIG. 5a), which can then in turn be attached to inner surface 21 of article 24 with stitching 31, or stitching type connections, or fastened with one or more fasteners 32, which can be buttons, snaps, hook and loop closures, or the like, which may desirably be releasable so the patch is removable and or repositionable.

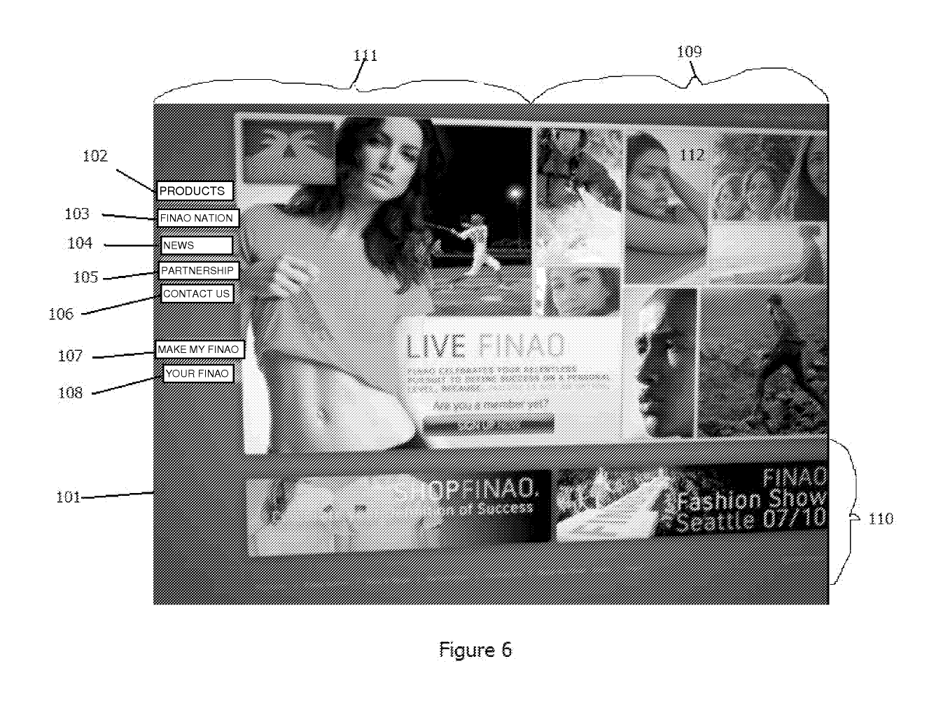

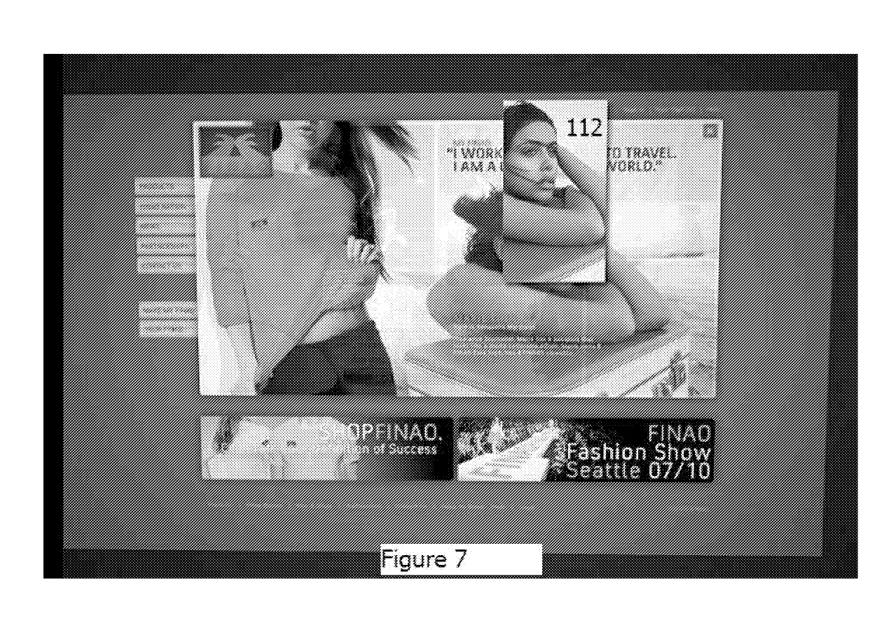

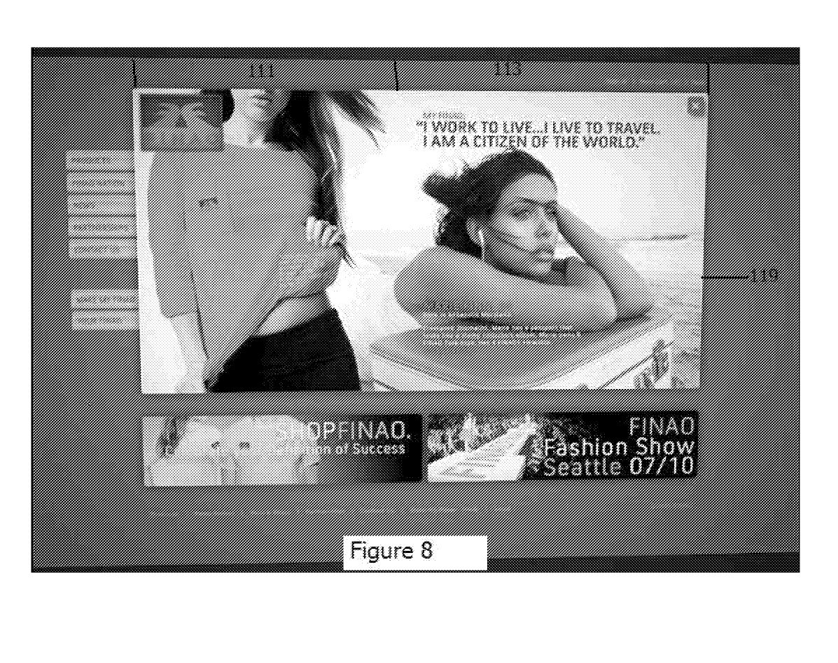

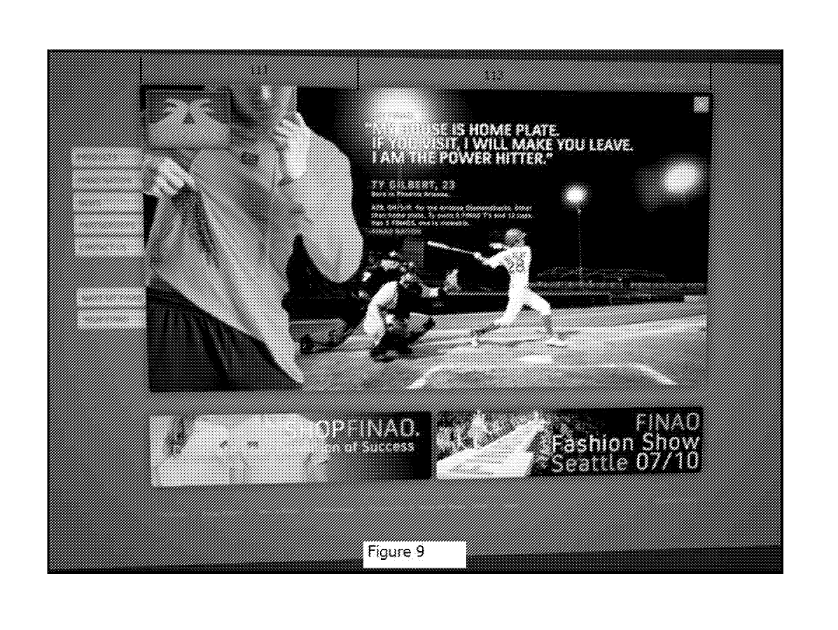

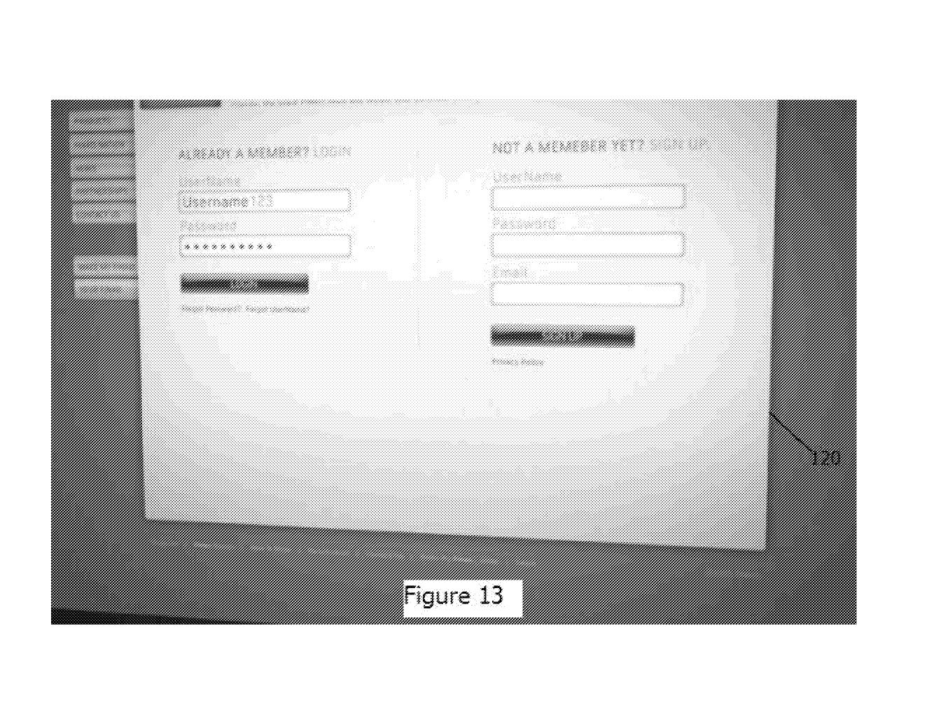

FIGS. 6-24 are screenshots of an embodiment of the disclosed system. FIG. 6 is a website home page 101; it has several tabs and several sections. Tab 102 is a products tab for displaying articles onto which a message may be transferred; tab 103 is for an interactive portion of the website, or community portal page, where customers can compare and discuss with each other their personal messages and message sharing adventures, as well as goals, progress, set-backs, and the like in pursuit of their personal definitions of success. Customers can also review each others' personal stored messages, for comment, for ideas, or the like. Tab 104 is a news tab for a page where news about customers and their adventures and achievements is reported and optionally reportable. Tab 105 is an optional tab, for example, a partnership tab, where projects and ventures may be proposed and discussed with other customers. Tab 106 is a contact tab for customers to get in touch with the website owner and article provider. Tab 107 is for a customer to go directly to creating their own personal inspirational message; tab 108 is for a customer to review their own collection of stored personal messages.

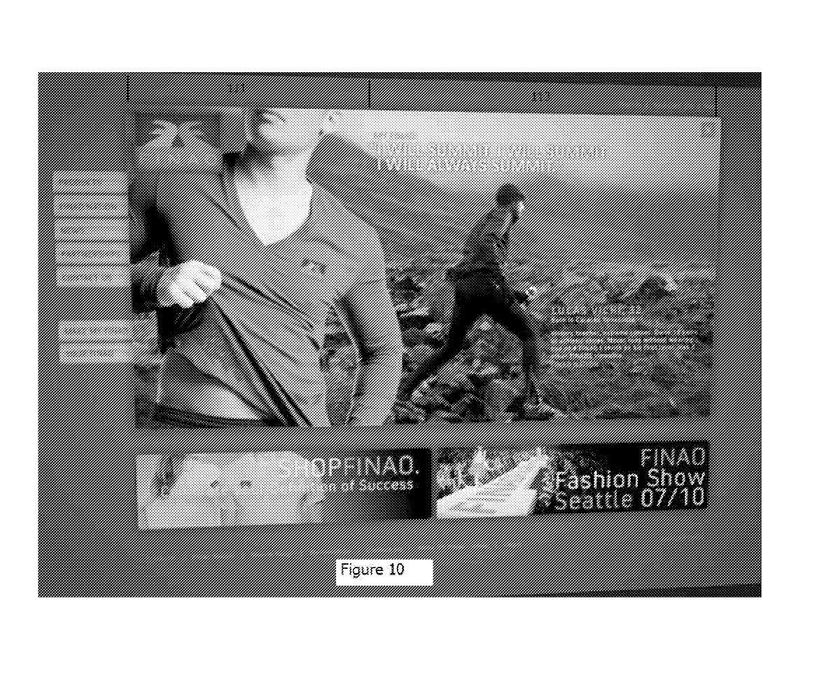

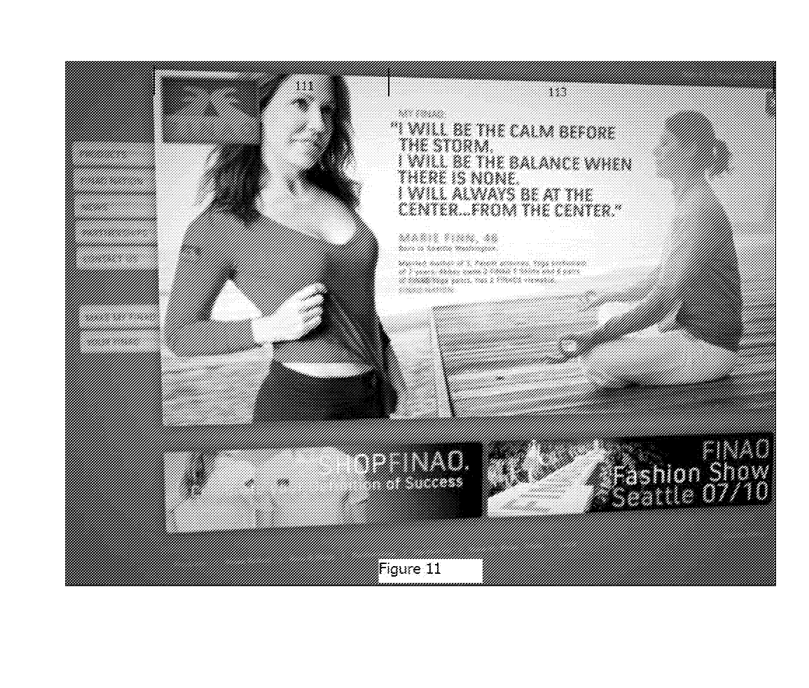

Section 111 is for optional graphic display for the website; section 110 is for bulletins, ads, notices and the like for the website. Section 109 is a montage of featured customers, the montage preferably changing constantly for every visitor over time, or changing every time the page is opened or revisited or for every different visitor, or changing for several or all of these events. The montage is composed of photos of customers voluntarily provided by them, and stored in a customer database operably connected to the website. When customer photo 112 is clicked, there is an optional graphic transition (FIG. 7), to a customer bio page 119 (FIG. 8) with the customer's bio and current selected personal message, and their photo in section 113 (optionally in the same frame previously occupied by section 109). Section 111 remains, but is advantageously changed to display a different product.

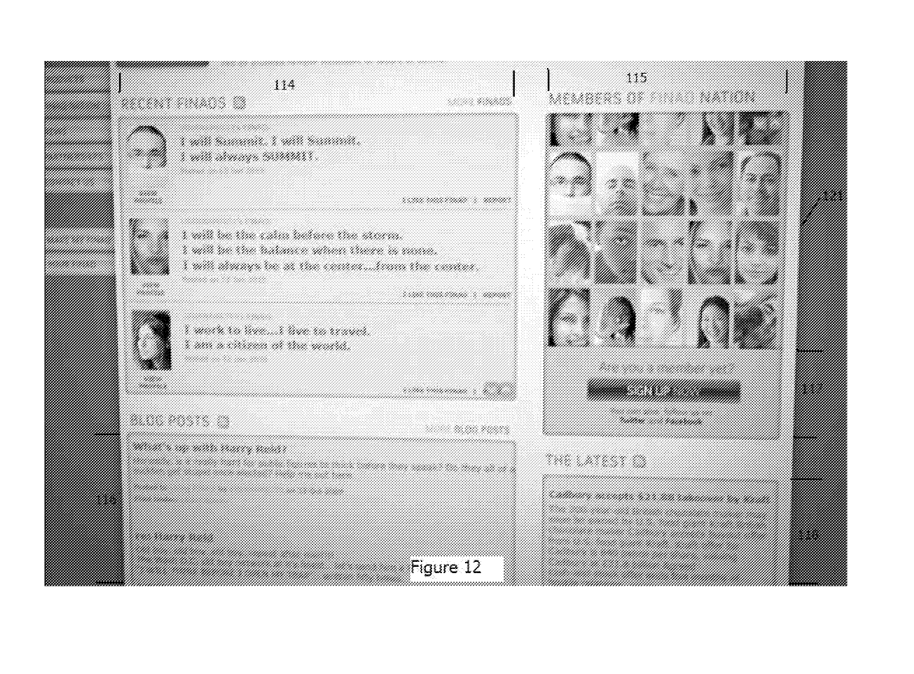

The displayed product is optionally related to some aspect of the featured customer's bio or message or personal interests (as stored in the customer database), and the displayed article is advantageously modeled in message sharing mode 22 with message showing in the display (if not legibly), and illustrating some of the many possibilities for ‘flipping’ the article or otherwise shifting it or altering its drape to reveal the message, and illustrating various styles or ‘attitudes’ than might be struck as part of the message reveal. FIGS. 9-11 are alternate displays to FIG. 8, illustrating different product displays in section 111 and different featured customers in section 113.

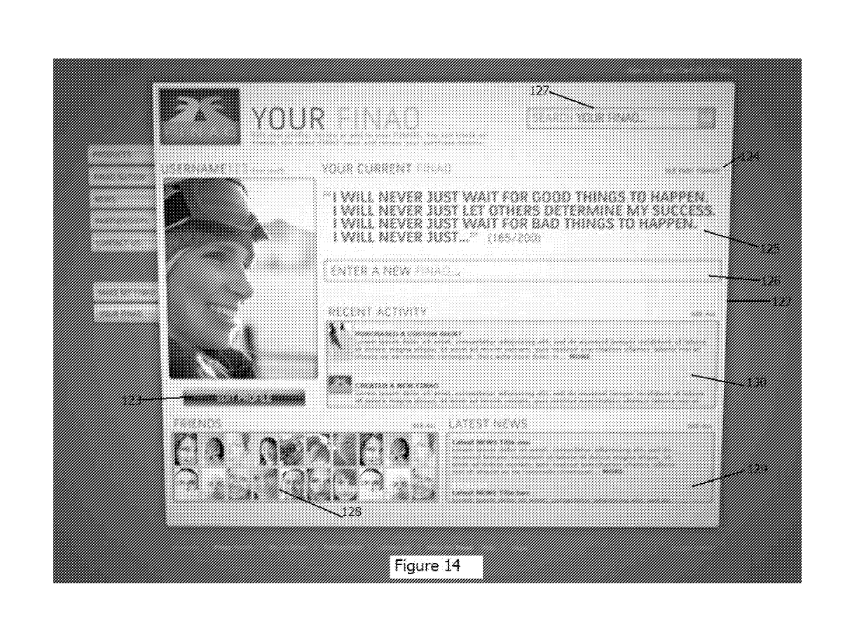

Clicking tab 103 at any time brings a customer to community portal page 121 (FIG. 12); once signed on to the website at section 117, customers can blog with other customers in section 116, search in section 115 for other customers by photo, name or interest, and review other customers' personal inspirational messages in section 114. Selected community news can optionally be displayed in section 118. Customers on this page can also link to various social media such as twitter and facebook, for instance in section 117.

Visitors sign in on page 120, FIG. 13. Tab 108 takes a customer to her personal message page 122 (FIG. 14), where she can optionally edit or establish her personal profile of data in the customer database from section 123, select a previously created and stored personal message in section 124, or create a new personal inspirational message in section 126, review her current selected personal message in section 125, find friends' personal messages in section 128, and get the latest news on the personal message sharing front in section 129. Clients can also review their personal purchase history in section 130, or enter key words to search for others' personal messages in section 127.

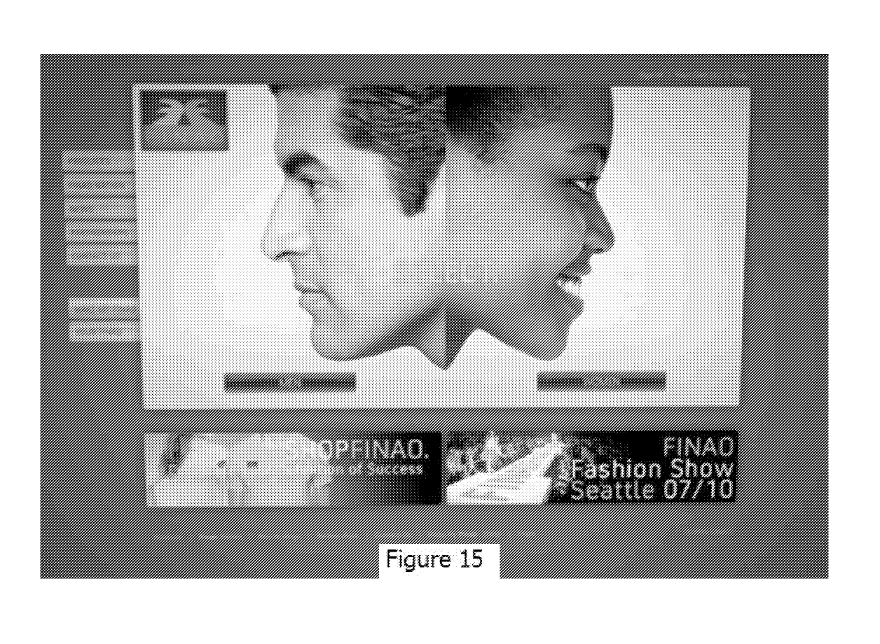

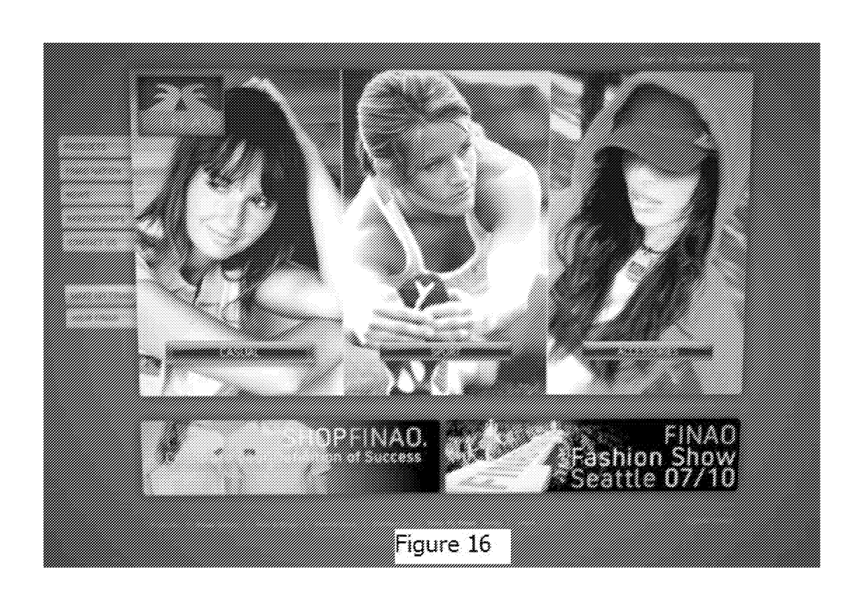

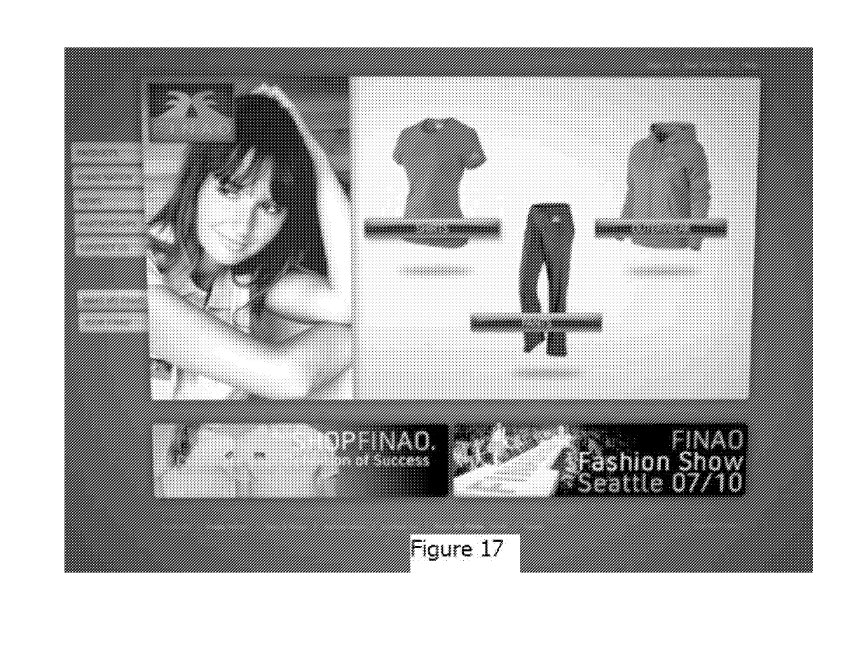

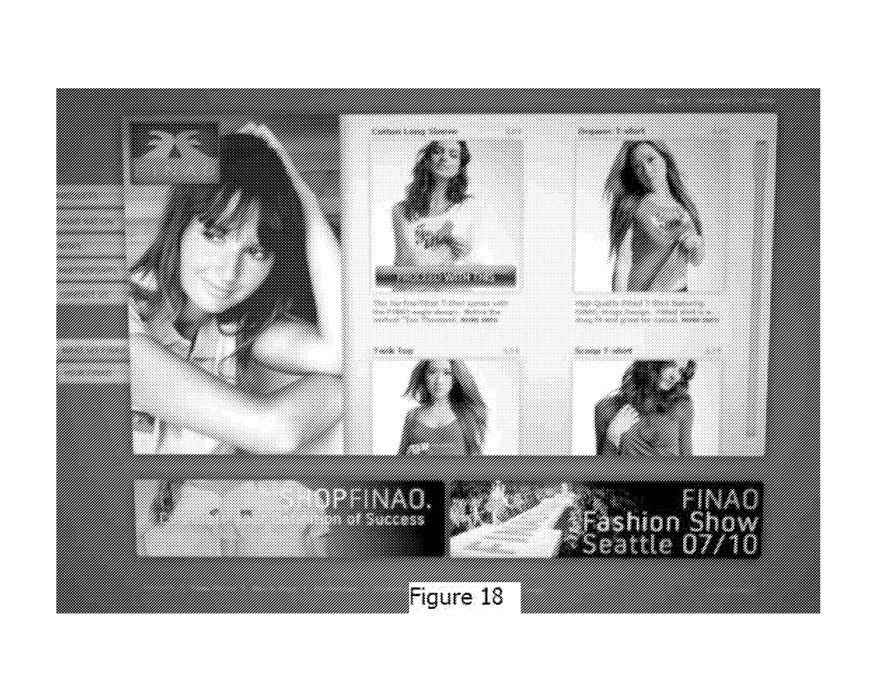

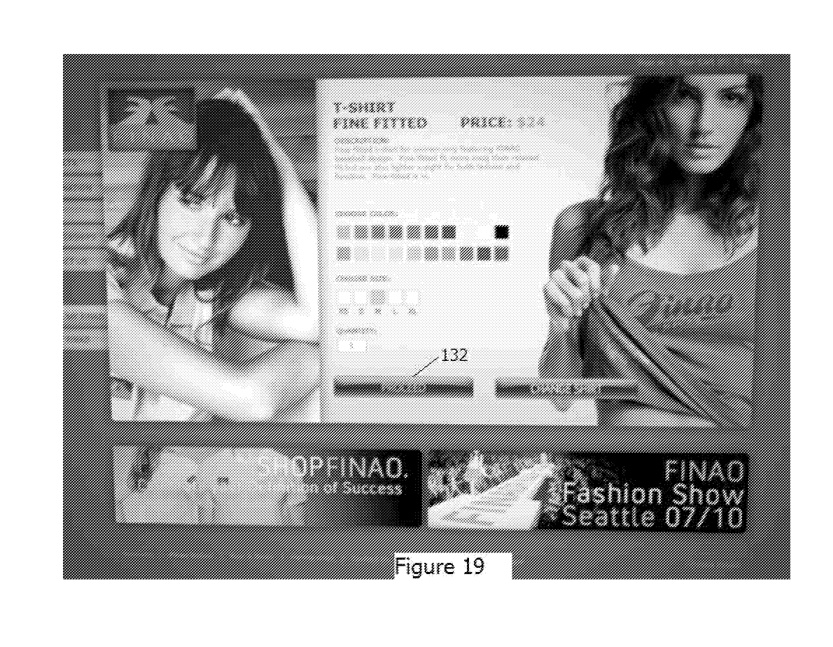

To shop for an article to which to apply a selected personal inspirational message, in FIG. 15 gender is first sorted; then in FIG. 16 category of apparel (i.e. casual, sport or accessories) is sorted. In FIG. 17 within category of apparel (casual is illustrated for example, and figure displayed for ‘casual’ remains) sub category is sorted; then an apparel item is selected in FIG. 18. A hover-over or button click allows the customer to proceed to color and size selection in FIG. 19.

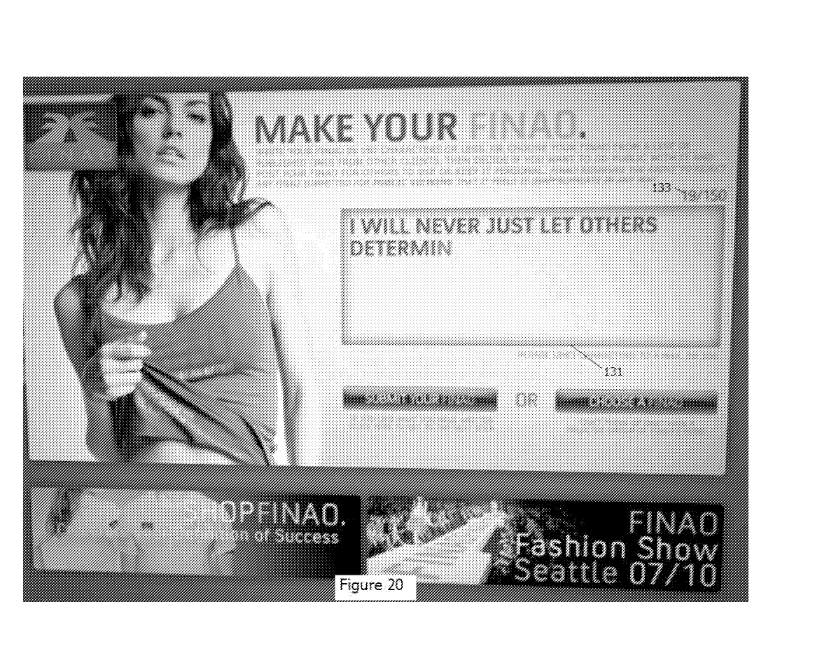

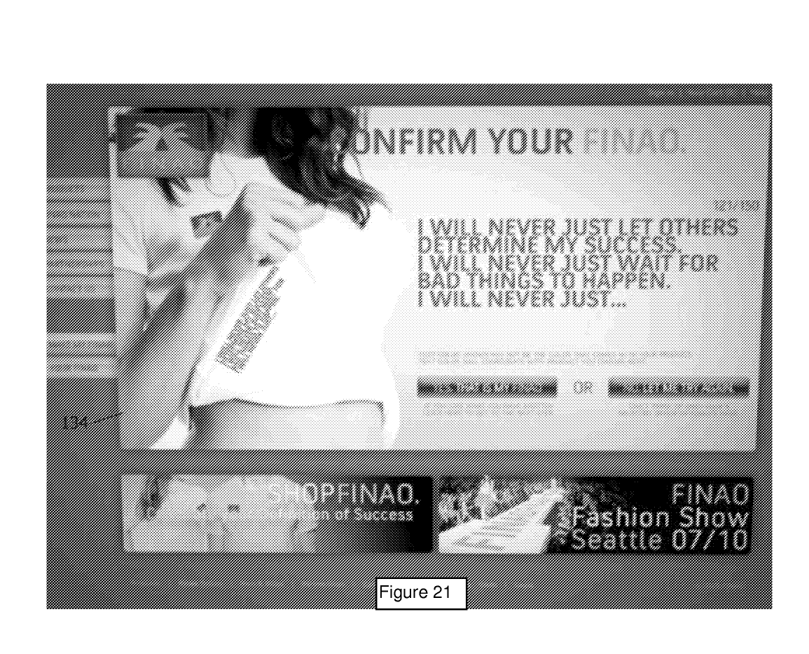

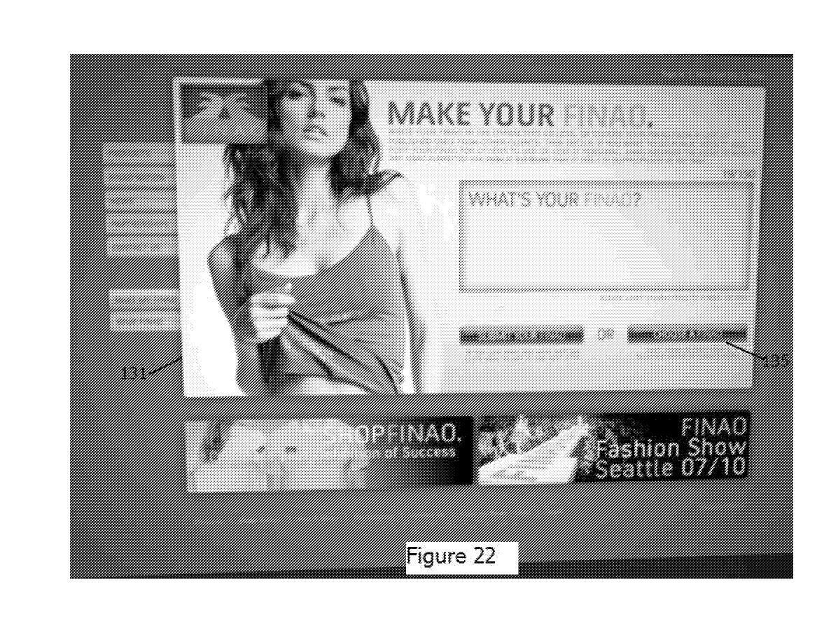

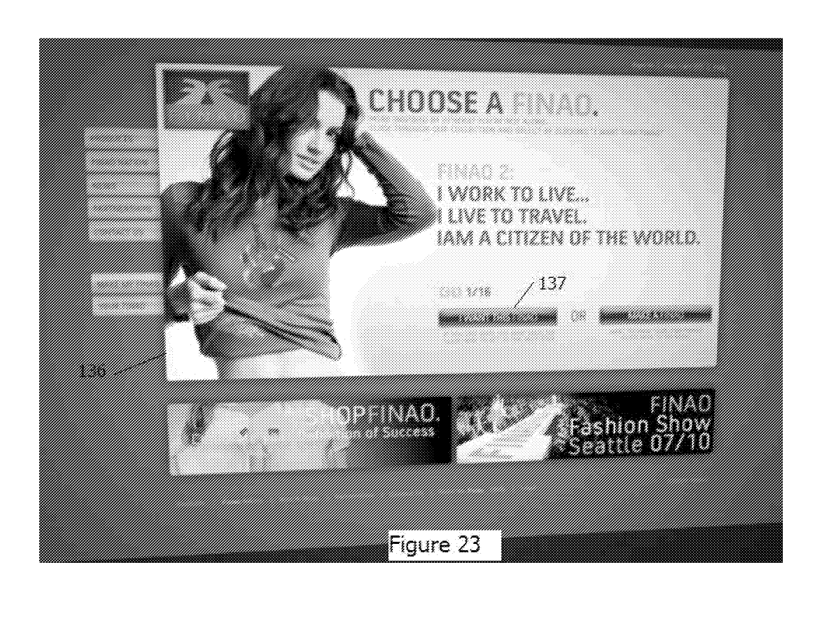

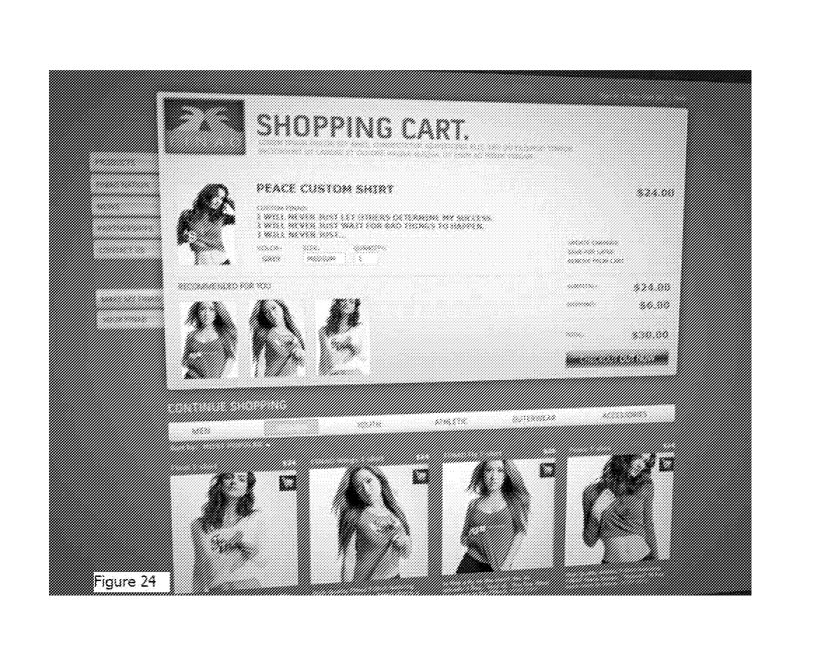

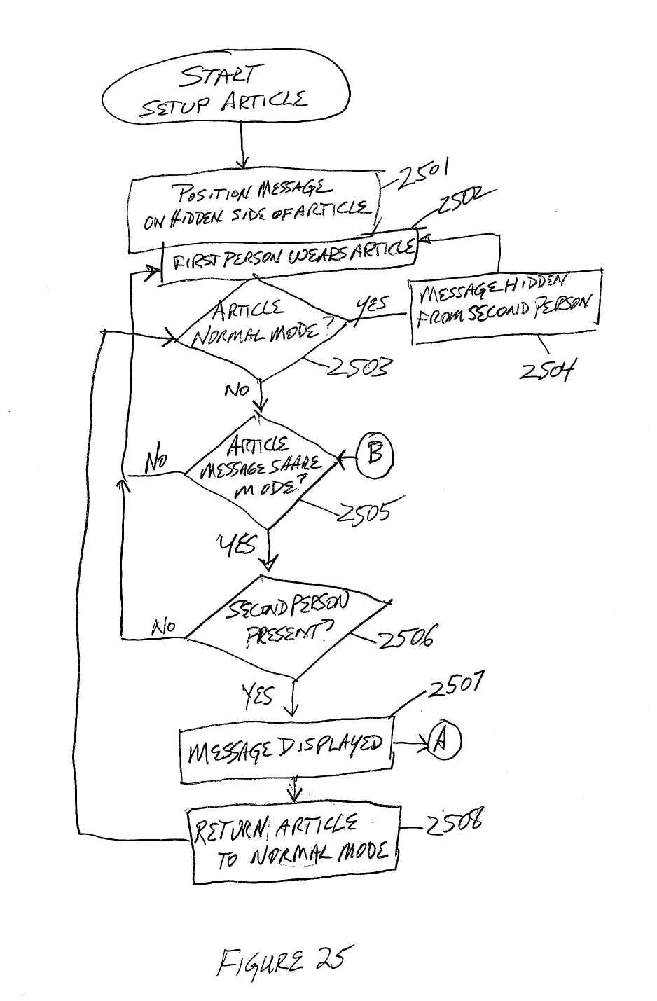

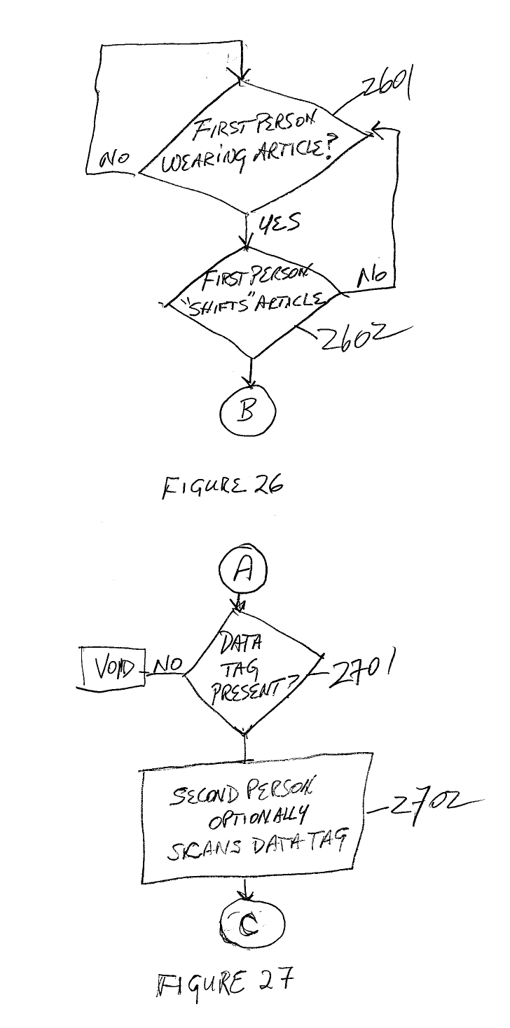

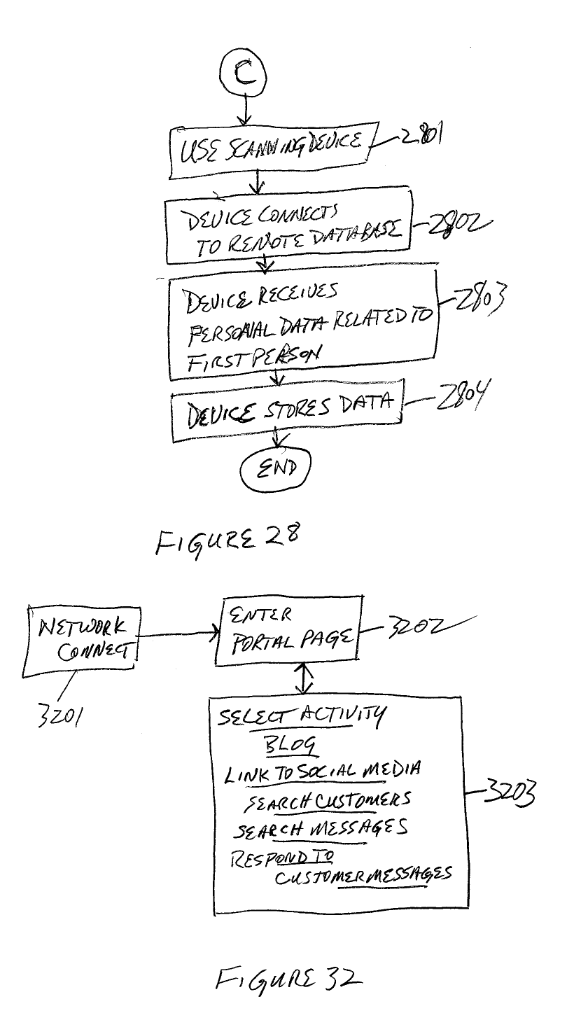

After an article is selected, the customer proceeds to page 131, if the desired personal message has not already been saved and selected, either directly from button 132 or via tab 107, to create a new personal inspirational message (FIG. 20). Composition area 133 is provided to compose a new personal message; optionally this area is set up to display the maximum number of characters a message may contain, and to count down the characters remaining, as the message is typed. Optionally, the personal message may either be shared on the site for others to read and possibly use for themselves, or kept private. An optional confirmation page 134 is provided where the message may be saved or started over (FIG. 21). If the customer wants to choose an existing personal message authored by someone else, she can click choose button 135 (FIG. 22), review various messages on page 136 (FIG. 23) and select one by clicking button 137. When article and personal message have been selected, the customer goes to checkout (FIG. 24).

One of the disclosures of this application is a sustainable system for celebrating relentless pursuit to define success on a personal level, for anyone who wants to, and to provide a supply and support infrastructure for that pursuit and those definitions. Whether it is a fight for work/life balance, weighted to the life side of things; or to finally complete that brutal charity run, on a third attempt; to take the hard way around a problem, for no other reason than that it's the right thing to do: Failure Is Not An Option. And the disclosed system provides both incentive, means, and infrastructure to support any one or thousands who want to work and live this way, and the system brings them all together, as well.

One embodiment functions as a conduit for customers to express and validate their personal definitions of success. The disclosed system achieves this by offering branded, ready to wear sportswear and accessories that contain a customer's unique and motivational message; these messages are printed inside each article or garment a customer purchases, underscoring its personal nature.

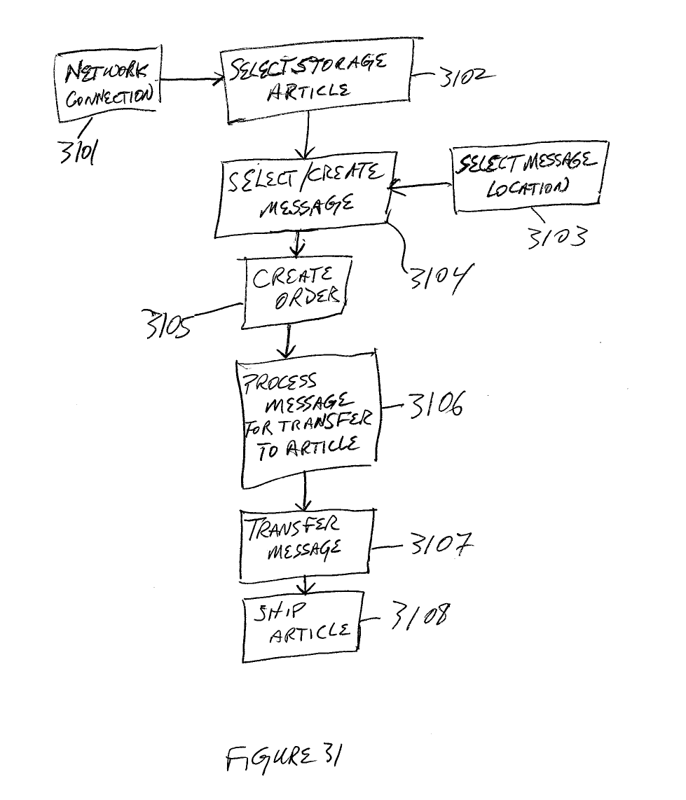

FIG. 29 schematically illustrates one aspect of such a system. Customer 210 uses computer 220 to access company computer 230 across Internet 240; customer 210 selects and orders an article (from database 238) and selects or creates a personal inspirational message to hide in the article via an order control module 250 operatively residing in computer readable memory on computer 230. The system also includes an message processing module 235 operatively residing in computer readable memory on computer 230. Message processing module 235 is used by customer 210 via computer 230 to create a new inspirational message, or to select from among inspirational messages previously stored in database 237, for a selected personal inspirational message to use with the selected article. Optionally the selected personal inspirational message may be stored as an image data file containing character information and/or other graphic or image information. Order control 250 then directs message processing 235 to send the appropriate form of message to article manufacturing module 260 which may also optionally reside on a computer and may either be same site interconnected with computer 230, or remotely located and connected either via direct line or via Internet 240. Article manufacturing module 260 is interoperably connected to image transfer module 265 which directs and controls the process of getting the image of the selected personal message onto the article in the selected location. Shipping is then handled from module 260 to customer 210, all in accordance with the handling of payment and shipping performed by check out cart module 239 operatively residing in computer readable memory on computer 230 for handling payment and shipping of the ordered article.

FIG. 30 schematically illustrates another aspect of the disclosed system. Customer computer 220 connects via Internet 240 to company web site computer 230; Website 280 is operatively set up to run in computer readable memory on computer 230, and website 280 includes community portal page 290 with blog module 292, customer interface 293 and social media link 291. Customer interface 293 is operably connected to databases 270 in which reside data about other customers that is thus accessible to the customer at computer 220. Customer thus has the option of visiting the company website and selectively interacting with selected customers and their shared (not private) personal data, including their personal inspirational messages and any accounts they may have to share about their activities in pursuit of their personal definition of success.

FIG. 25 is a flowchart schematically illustrating the steps of a method embodiment for storing a hidden, selectably sharable, personal message. 2501—a personal message is positioned on a hidden inner side of an article; 2502—a first person wears the article. 2503—if the article is in ‘normal mode’, the message remains hidden—2504—and the wearing continues. 2503—if the article is not in normal mode, but is in ‘message share mode’—2505—and a second person is present—2506—then the message is displayed—2507—until the article is returned to normal mode and the message is hidden again—2508.

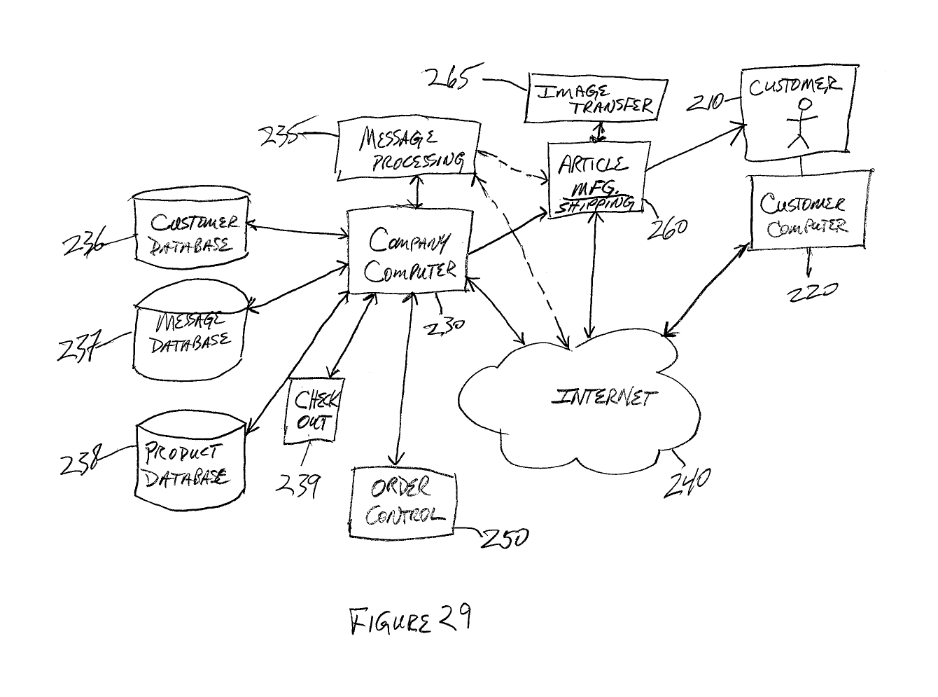

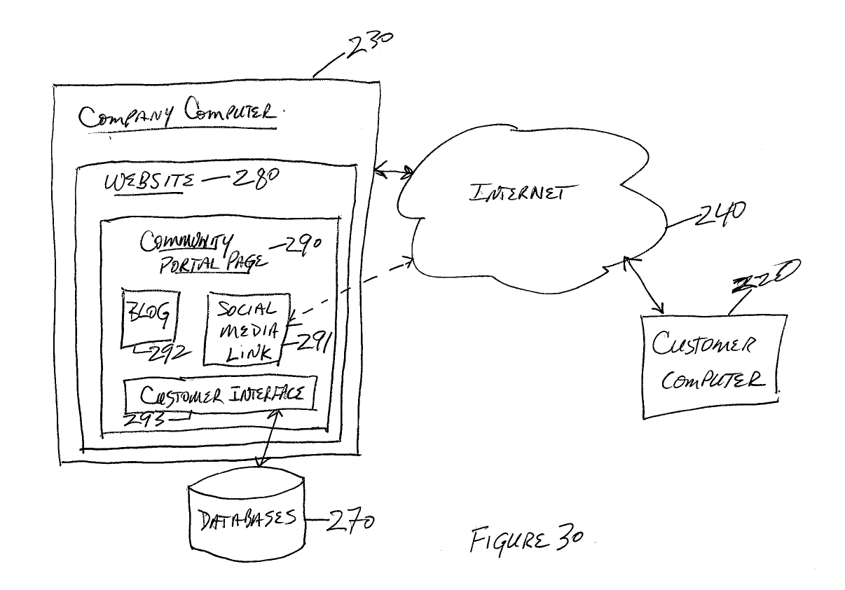

In FIG. 27, at circle A, if there is also a data tag present—2701—then the second person can also optionally scan the data tag—2702—for retrieving personal contact information from the first person. In FIG. 28, at circle C, second party uses scanning device to capture electronic code—2801; device connects through internet to remote database—2802; device receives personal data of first person that is operably related to the captured code—2803; the device stores the data for making future contact with the first person—2804.

In FIG. 26, if first person is wearing the article with the hidden message—2601, the first person can ‘shift’ or ‘flip’ the article so as to reveal the message—2602; otherwise not. This process ends at circle B and circle B is an input into step 2505 in FIG. 25.

FIG. 31 schematically illustrates a method for creating and ordering a personal inspirational message storage article. Via network connection—3101, a storage article is selected—3102; a message location on the article is optionally selected—3103, and a message is selected or created—3104. An order is created with this information—3105, the message is processed for transfer to the article—3106, and the message is transferred—3107. The completed article is then shipped—3108.

FIG. 32 schematically illustrates a method for networking with others about stored and shared inspirational messages. Via a network—3201, a customer enters a portal page on a website devoted to using and sharing selectively hidden personal inspirational messages—3202. On the site, the customer can select activity—3203—including blogging with others about messages and what they mean and how they are used and shared and what comes of that in the world, or linking to social media, or searching for other customers to share with, or searching for inspiring messages and the customers they represent, or responding to queries posted by other customers about the customer's own messages or usage thereof.

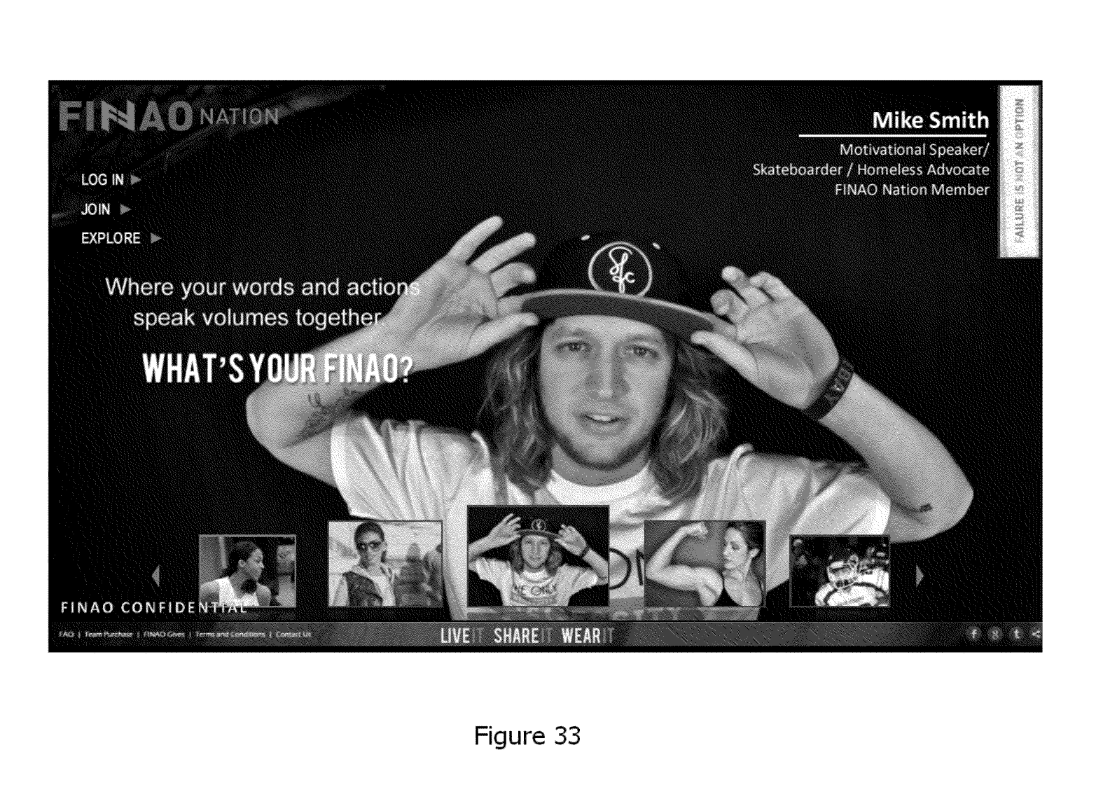

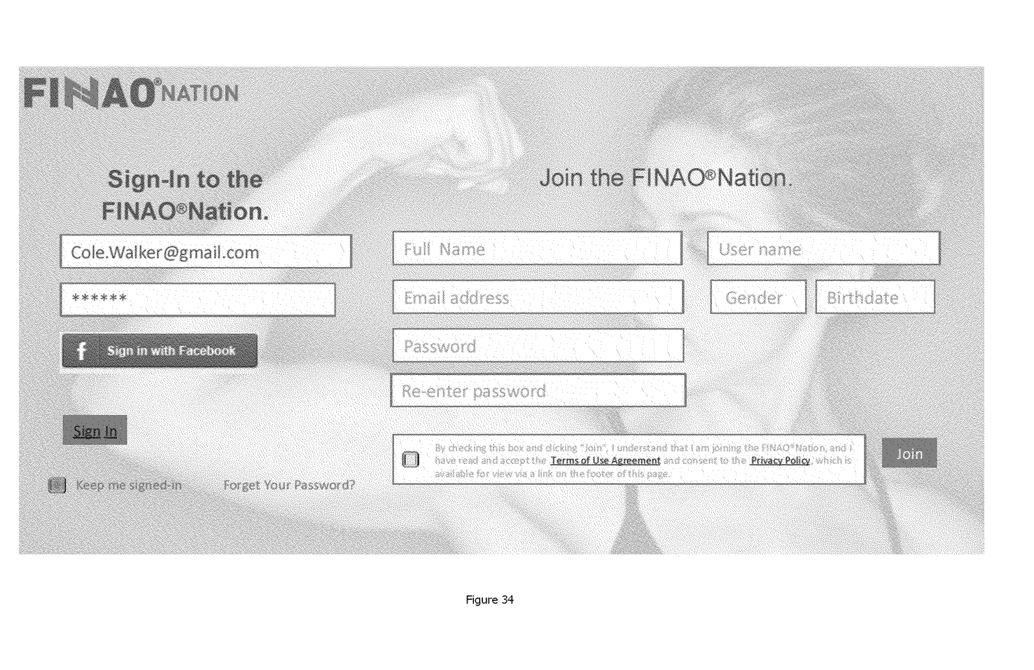

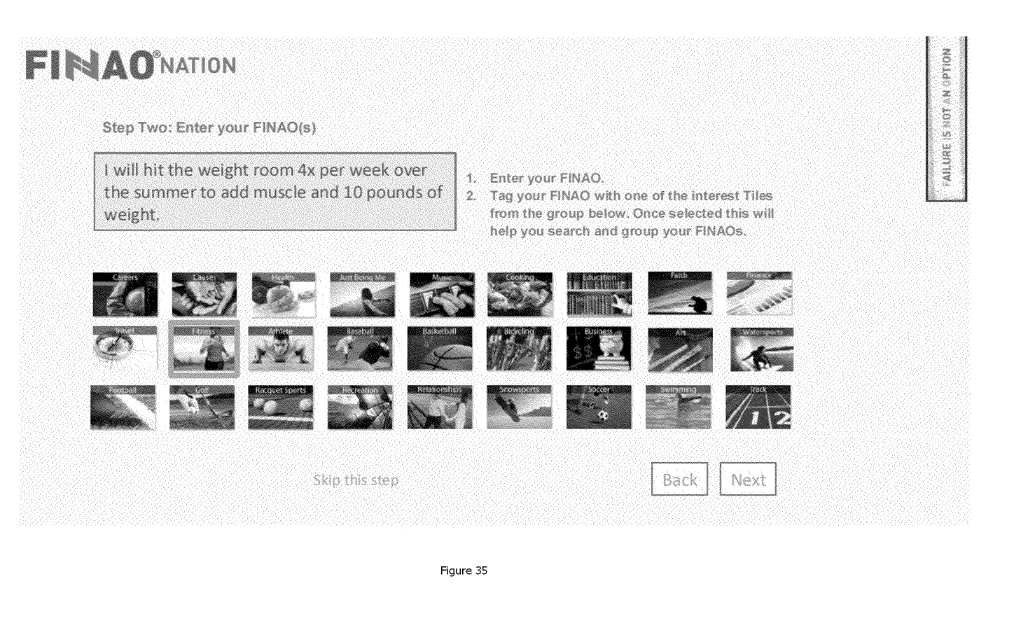

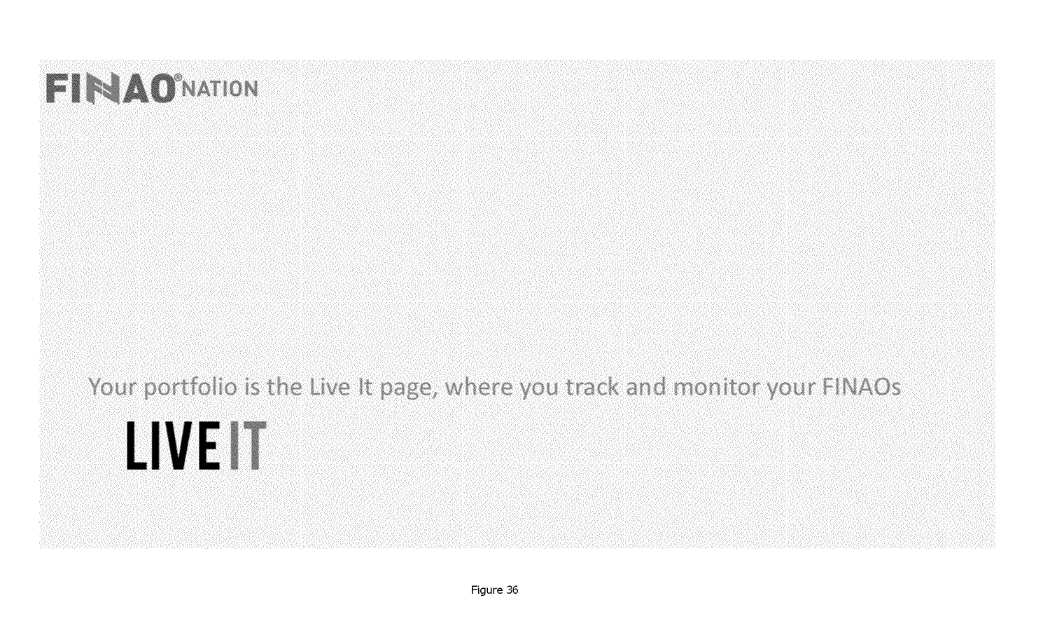

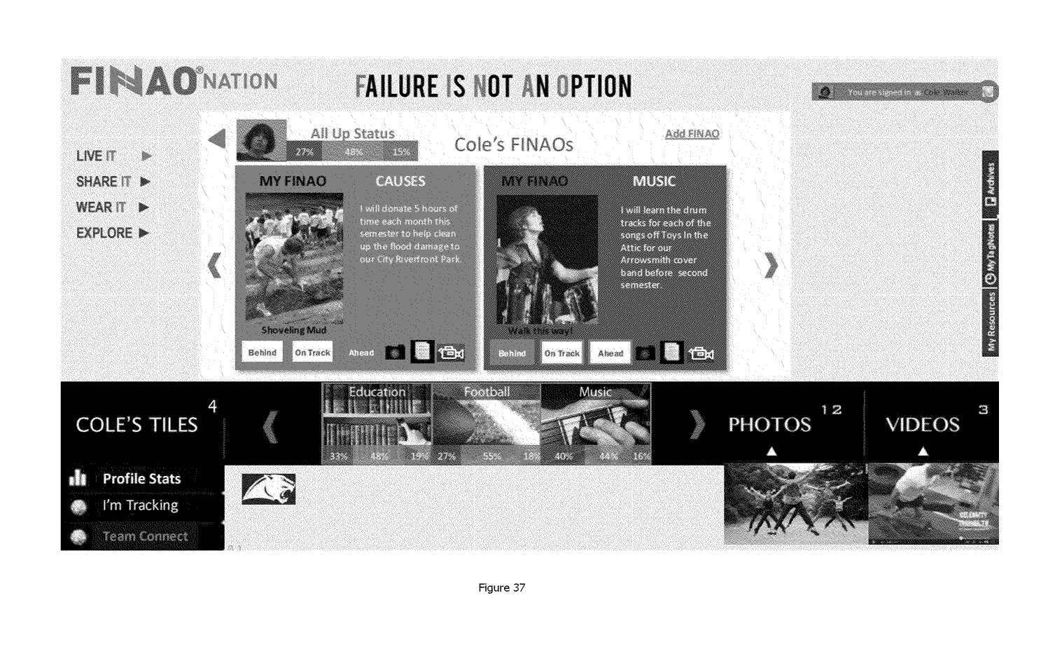

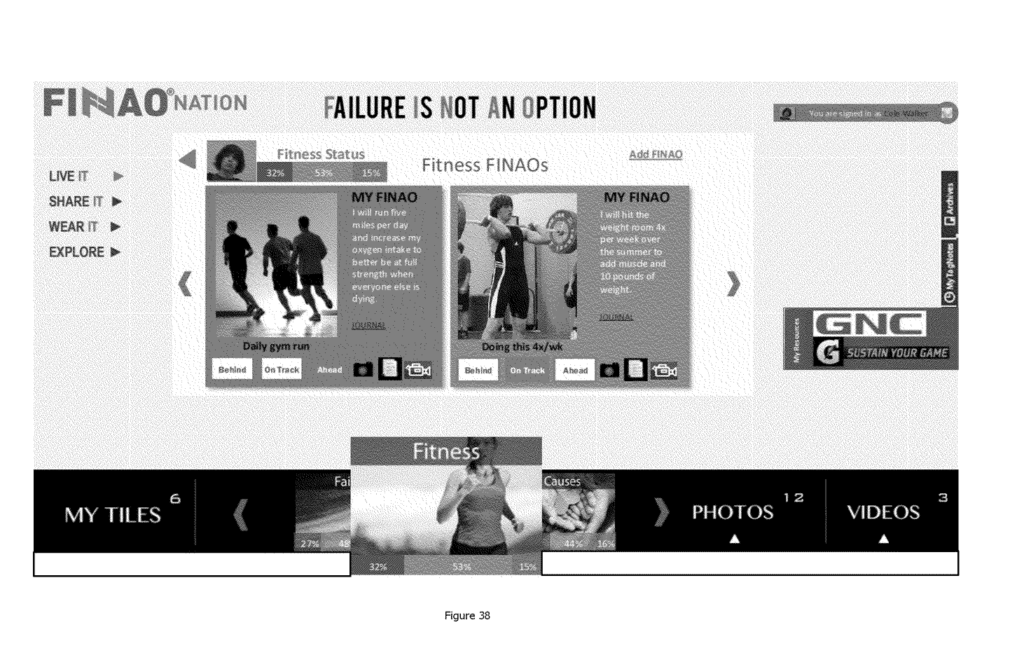

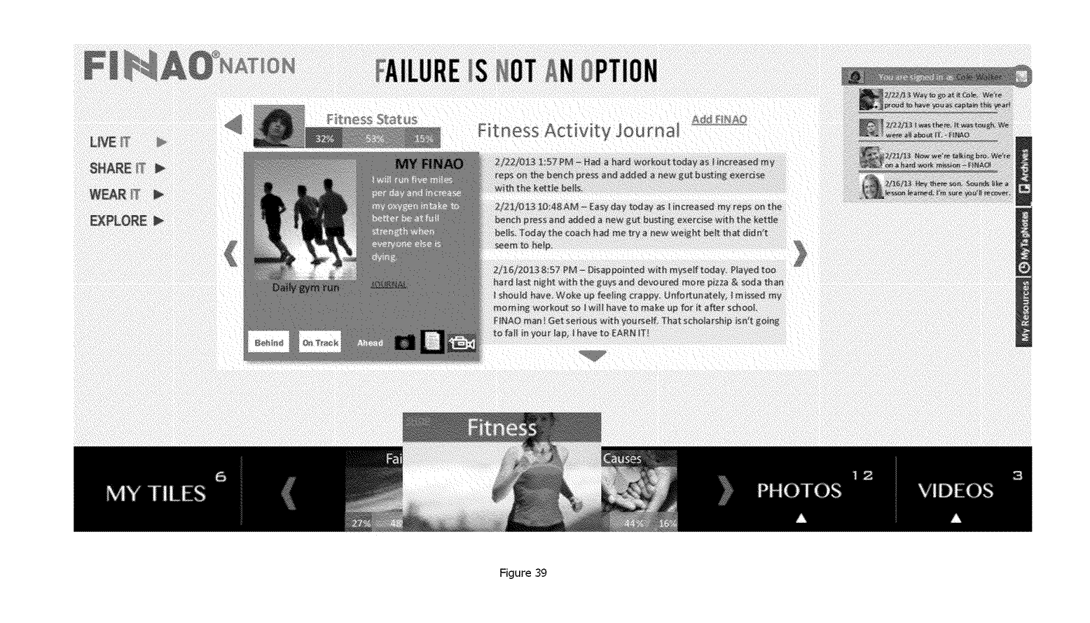

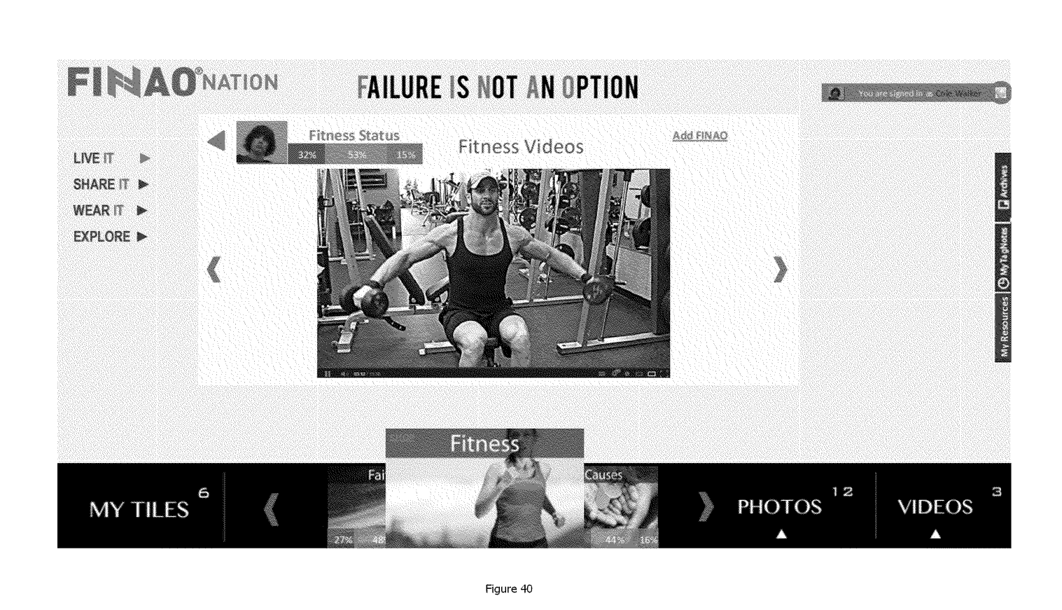

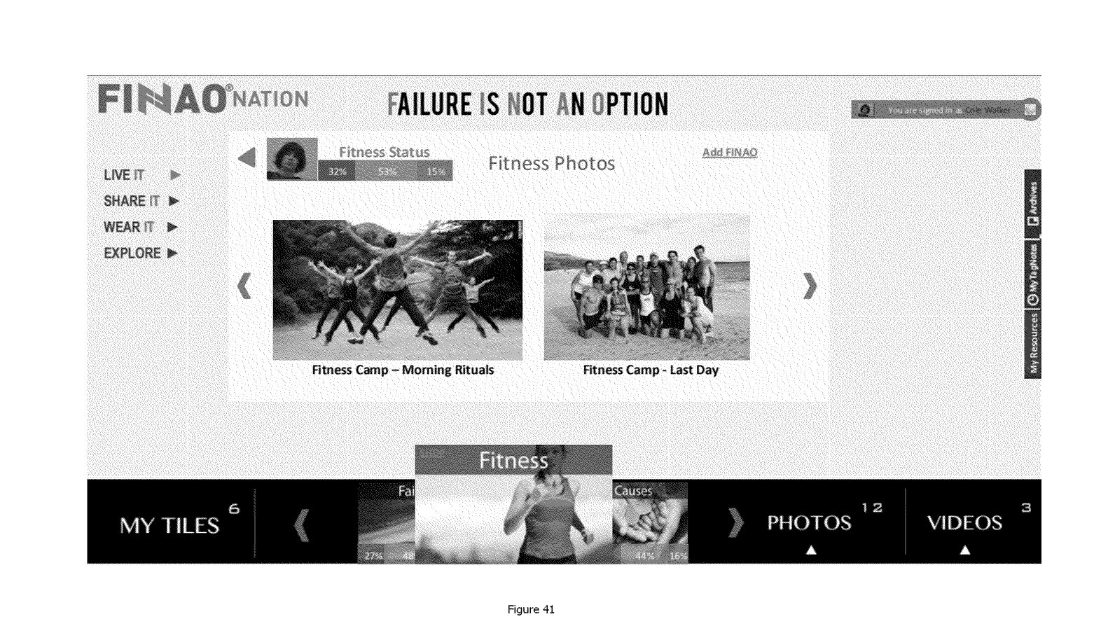

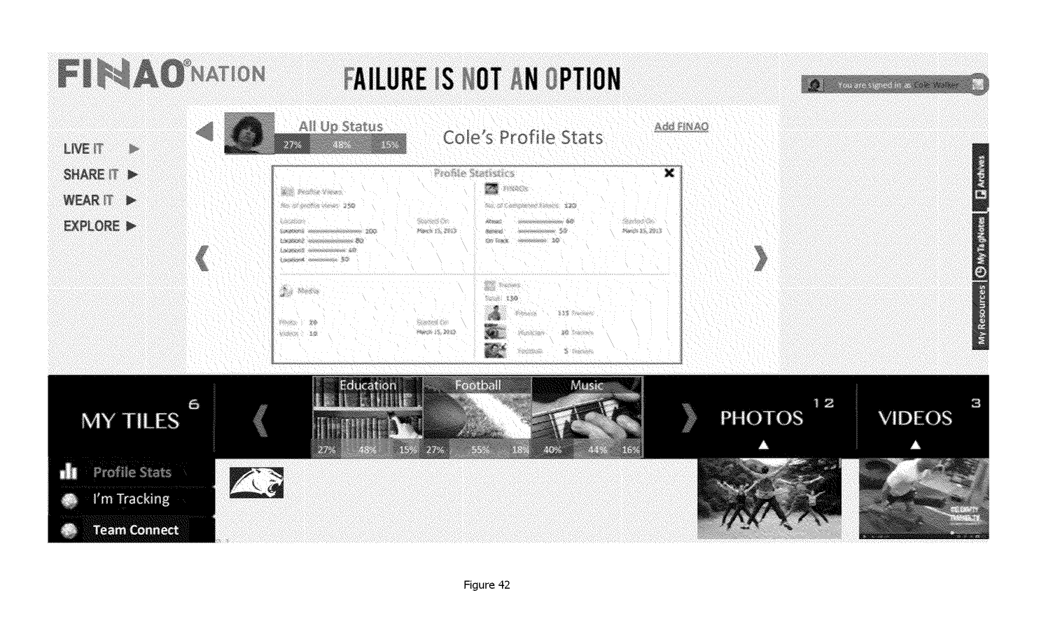

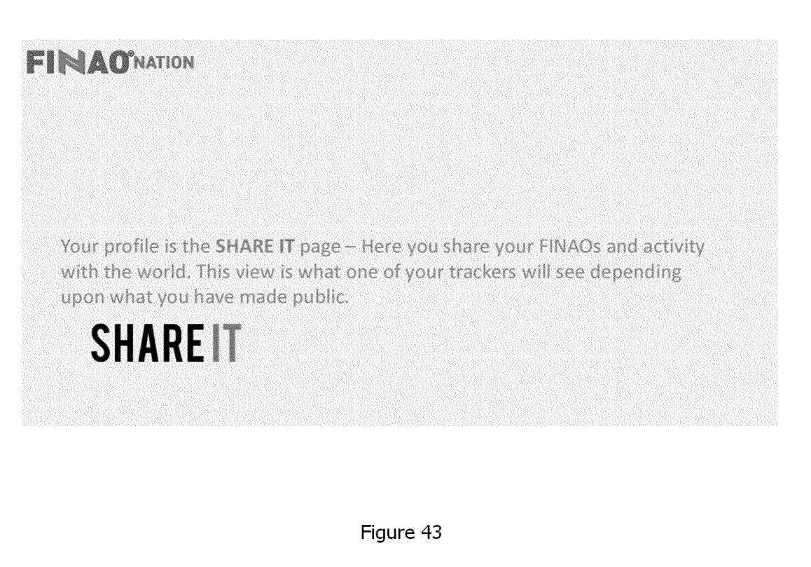

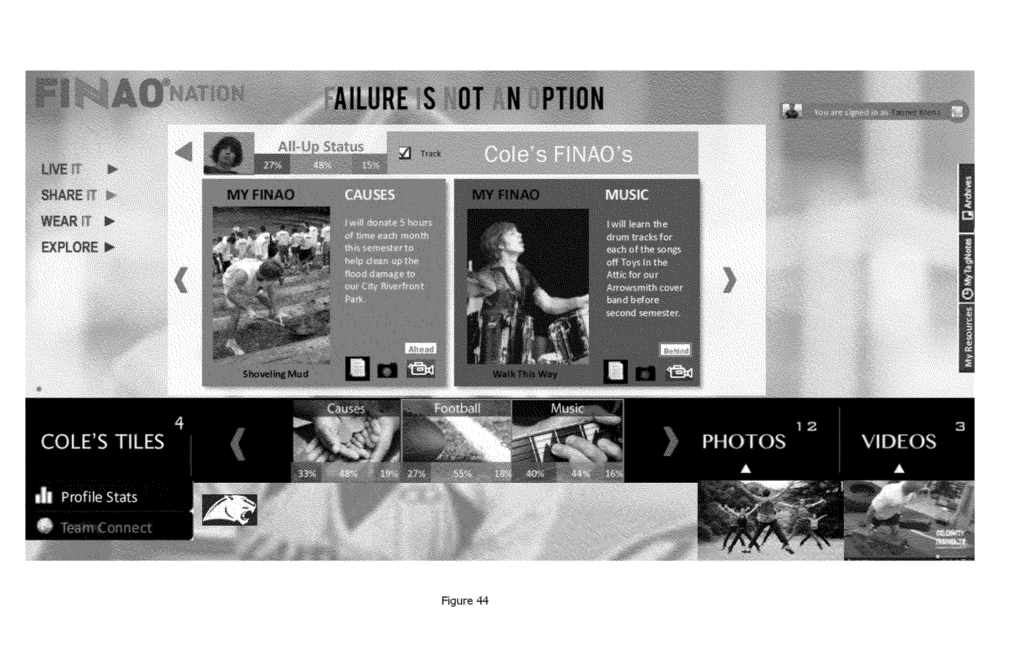

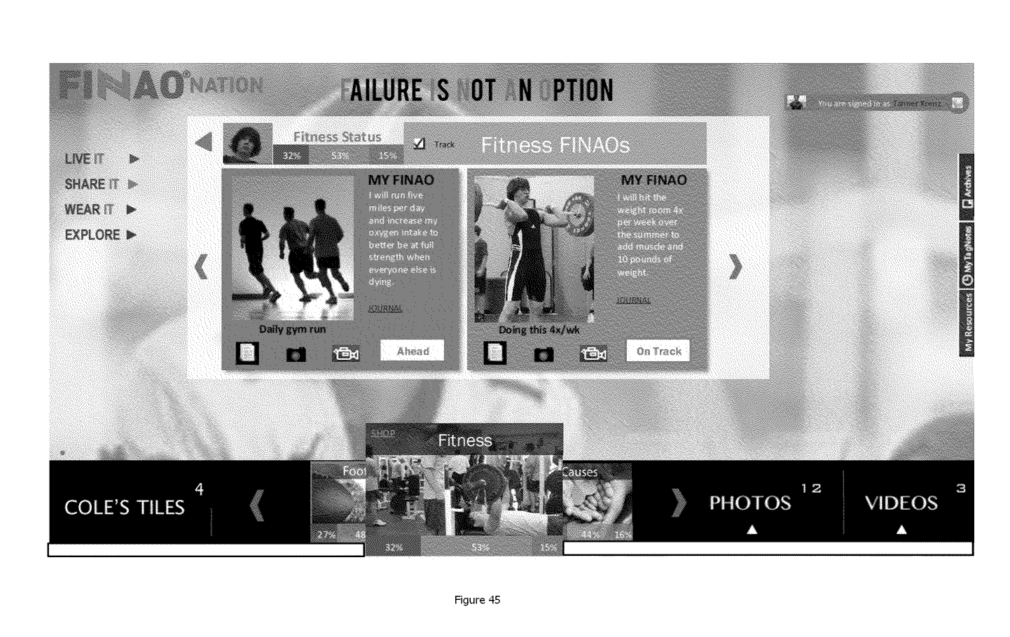

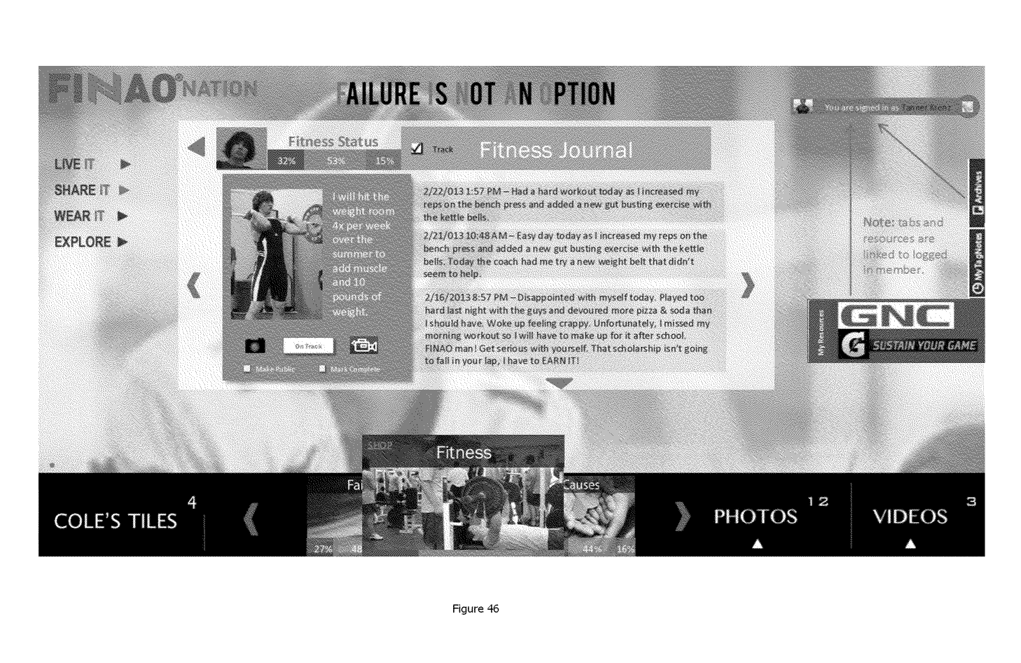

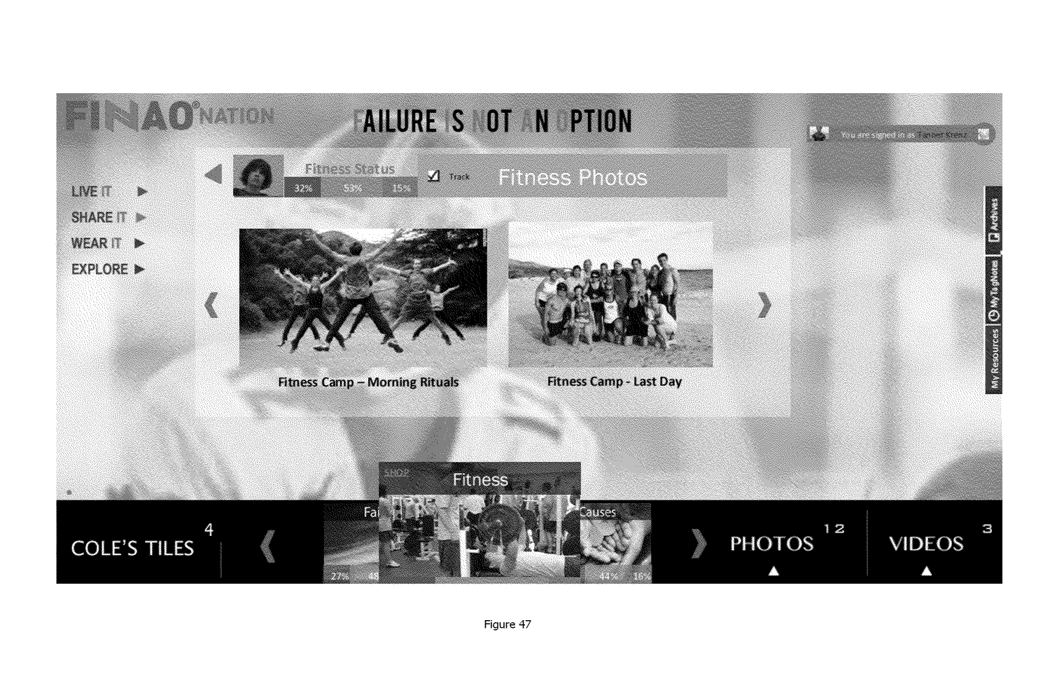

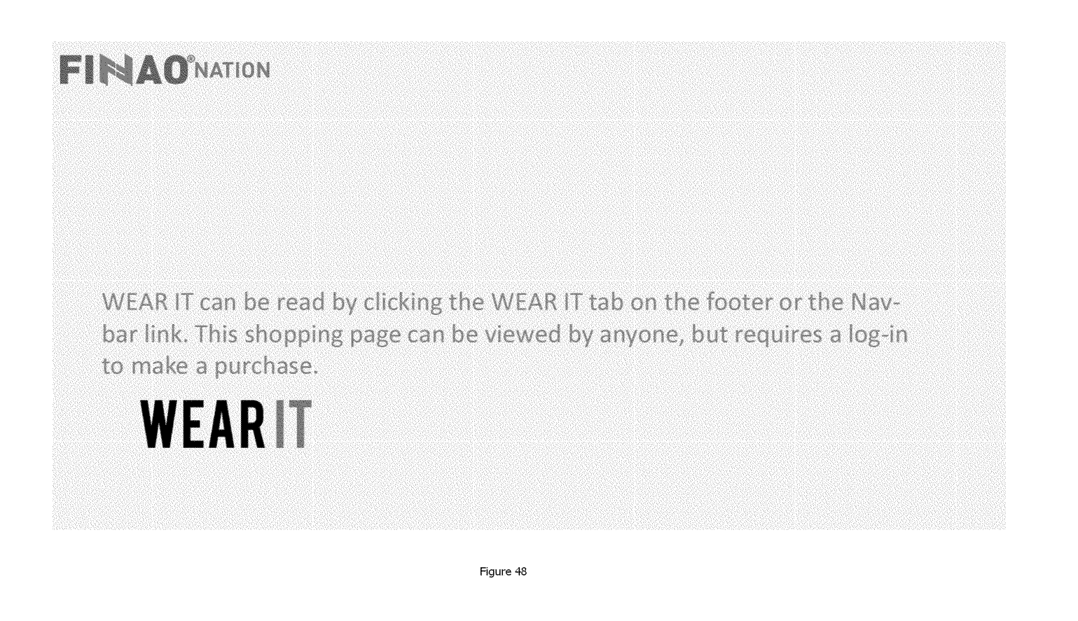

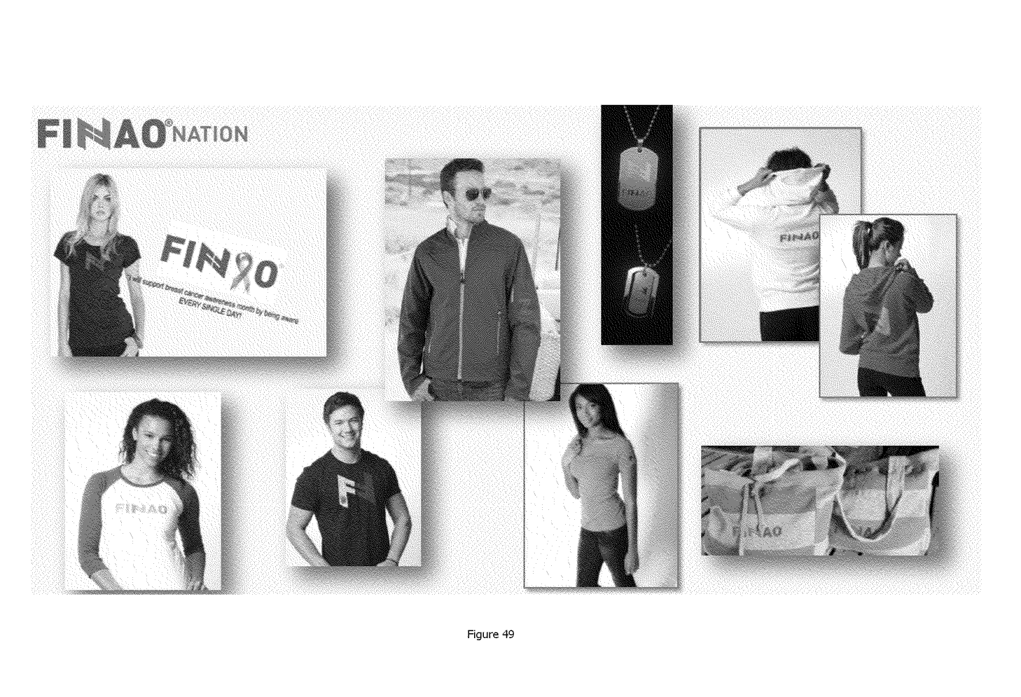

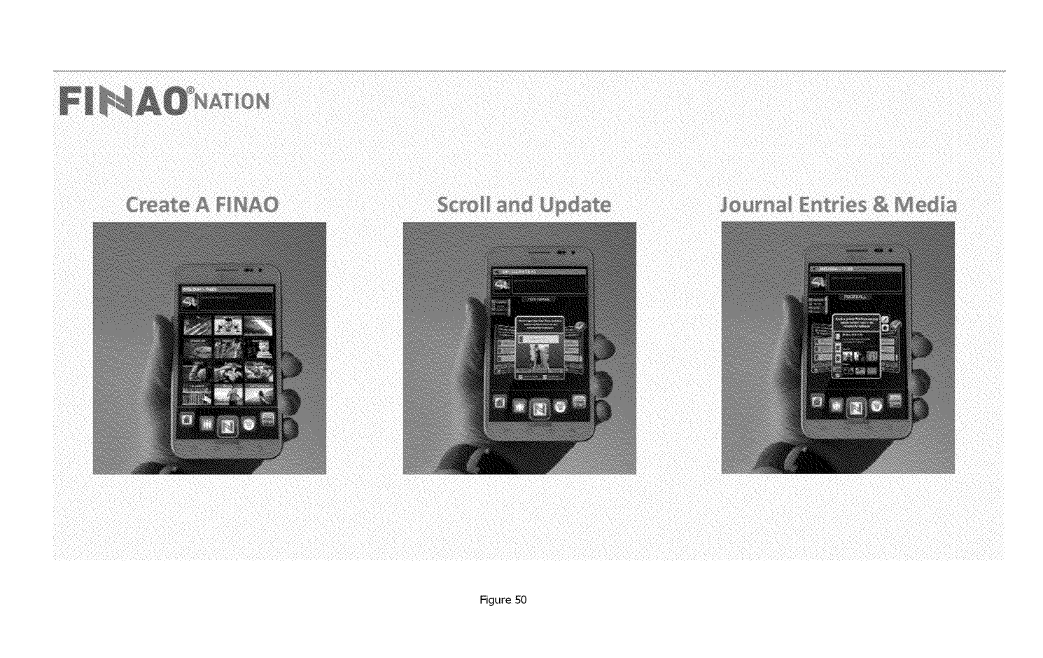

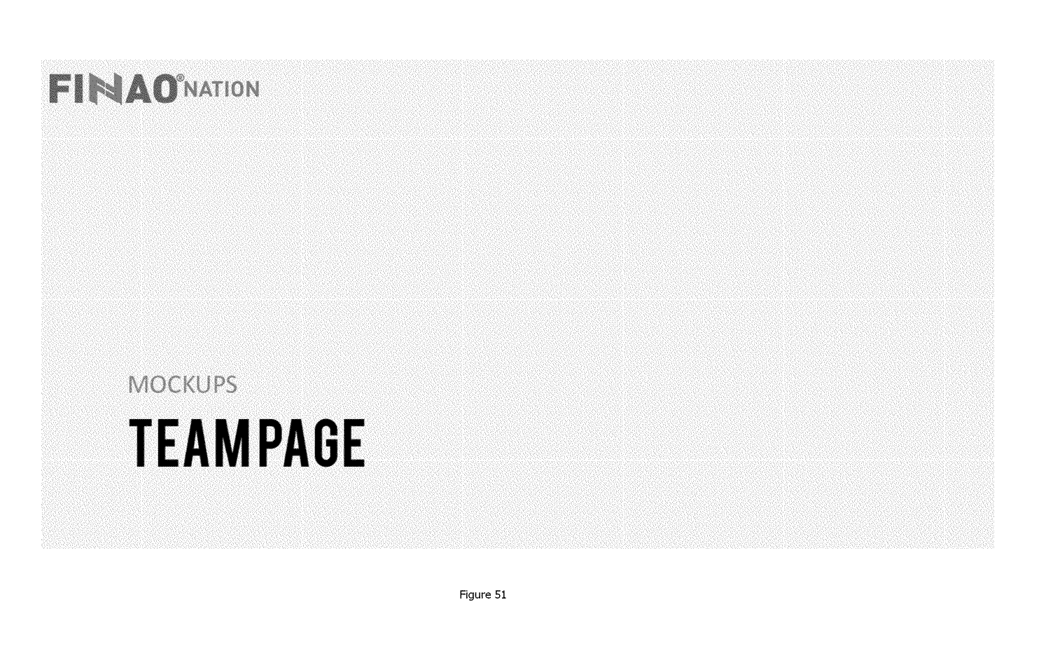

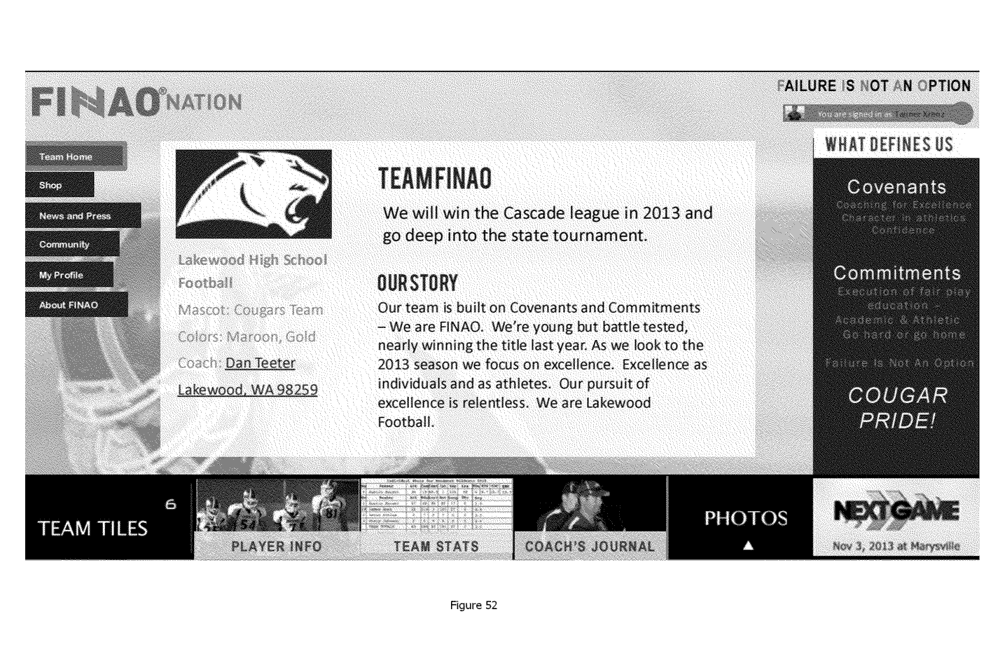

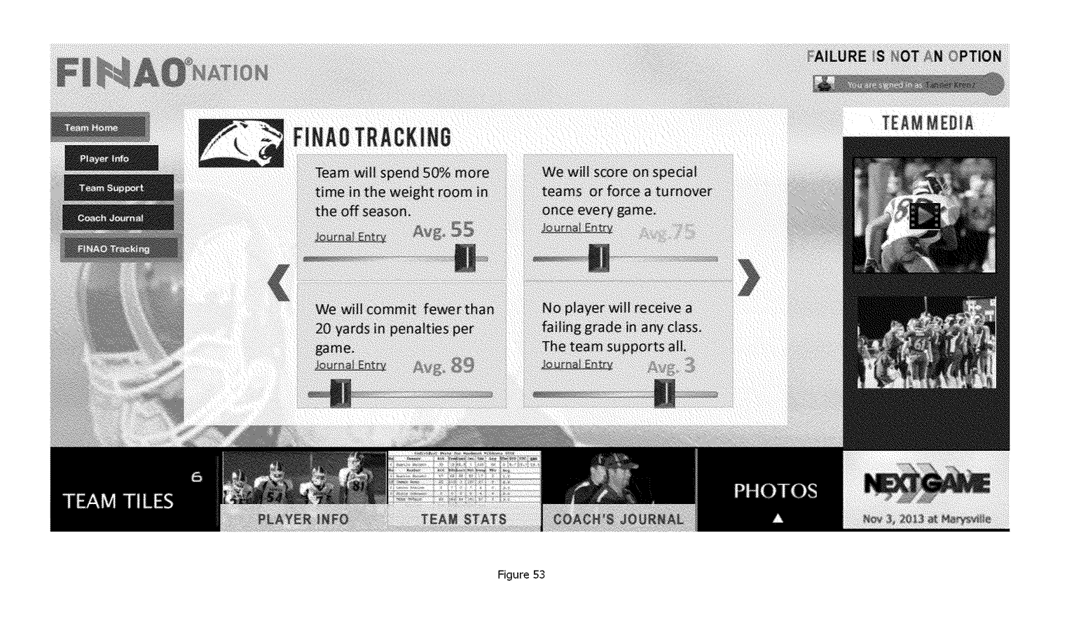

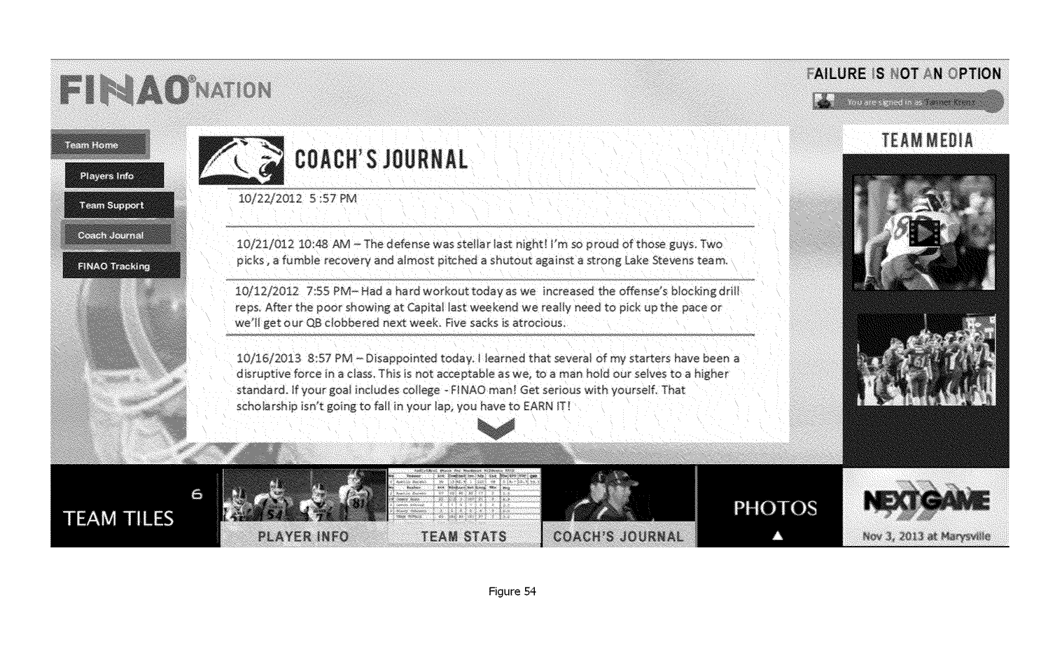

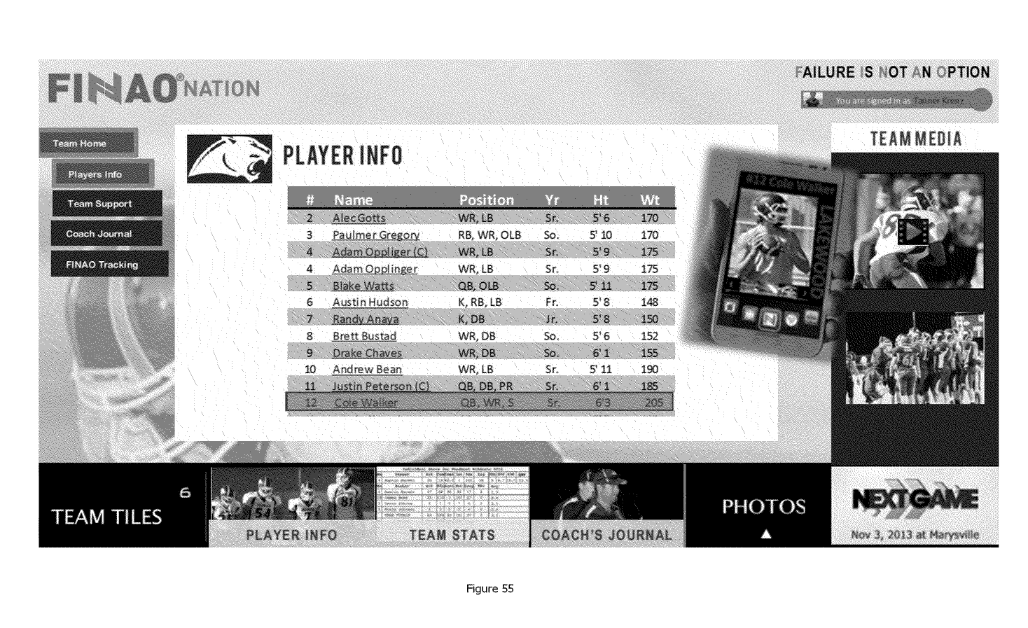

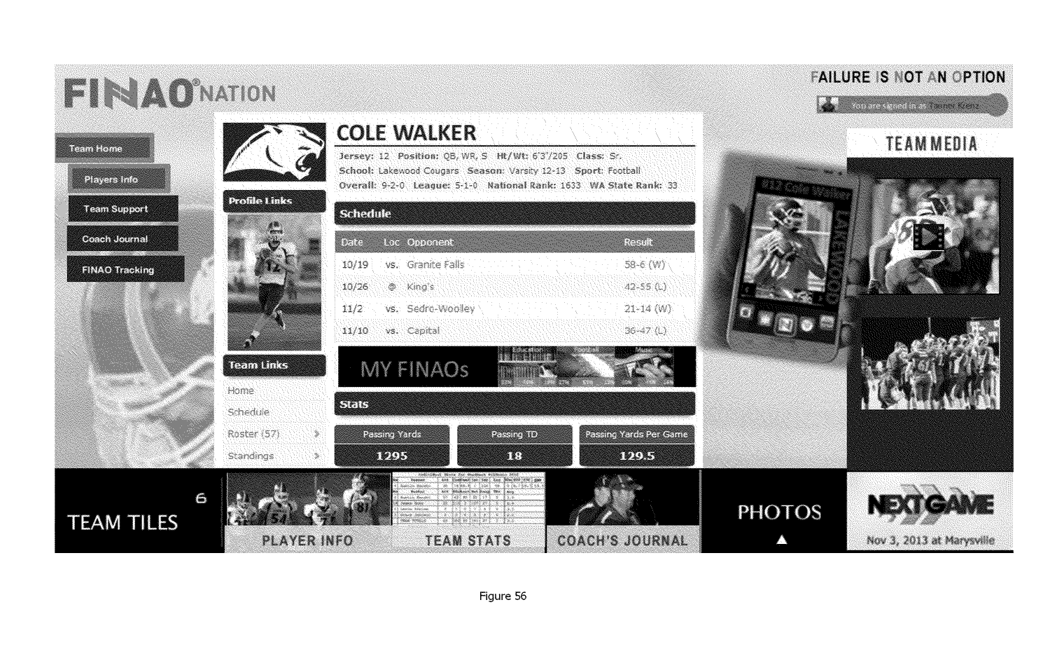

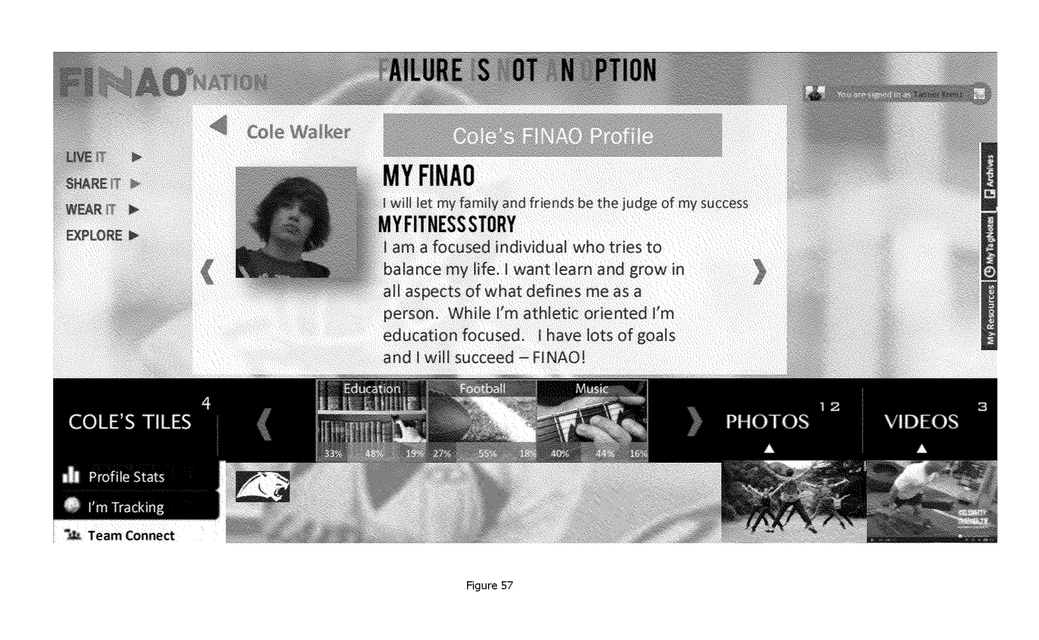

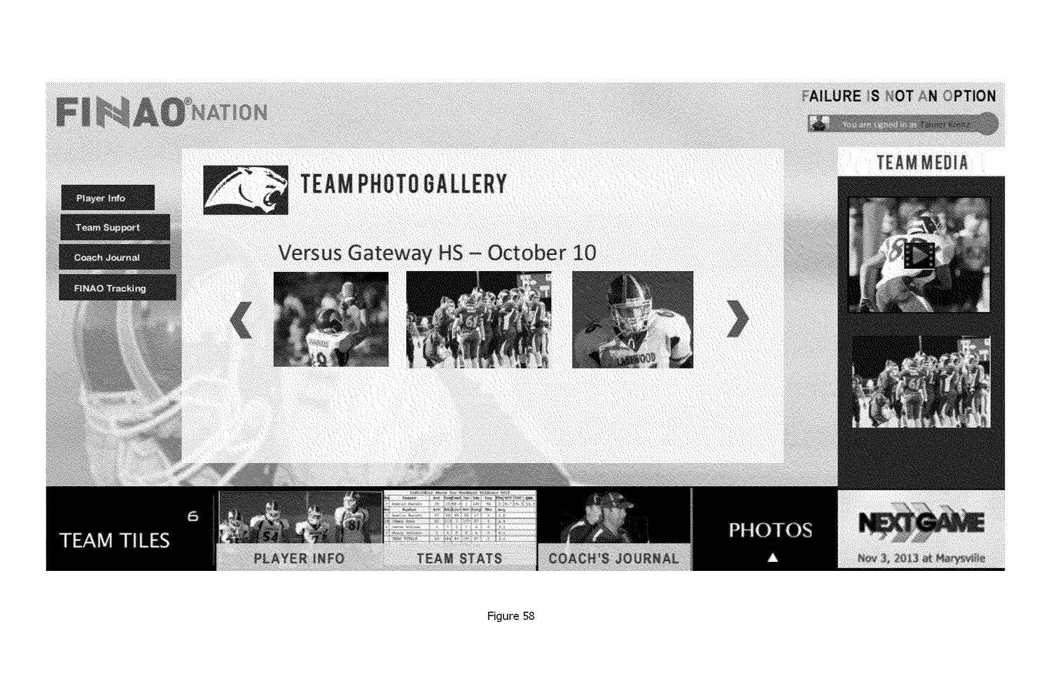

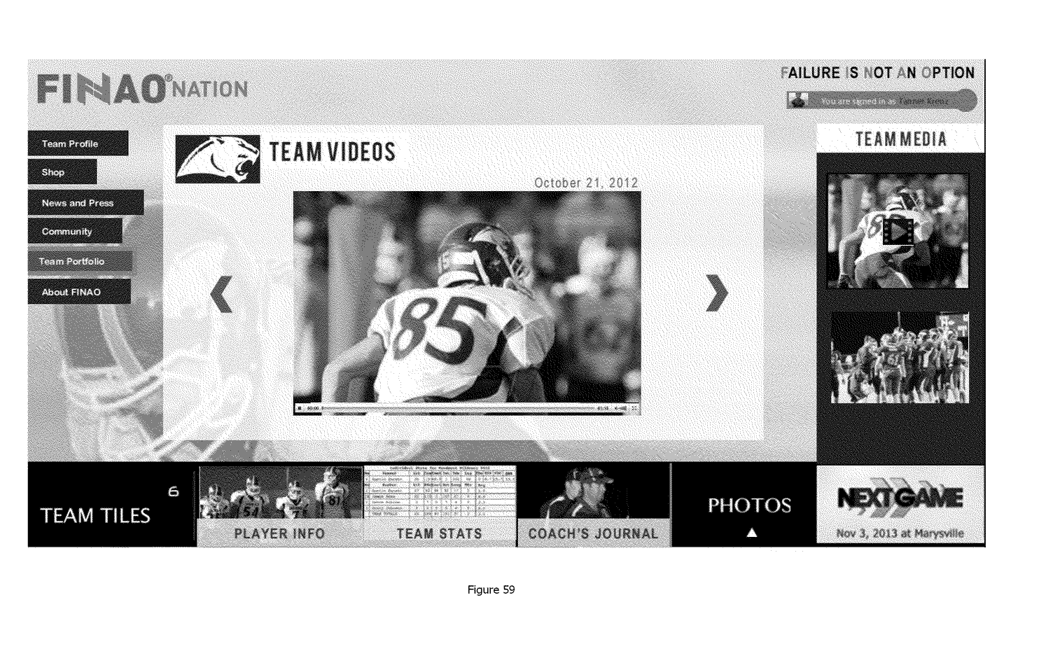

An additional portion of the web site as shown in FIGS. 33-59 is constructed in the parts of “LIVE IT, SHARE IT, AND WEAR IT” and is a system and workspace for goal creating and tracking. It also serves as a hub, a profile, and a tie to branded garments.

In this portion of the site all personal FINAO activity is managed in a secure and easy to navigate manner. Here are some of the things you can do in LIVE IT:

### Capturing FINAO Goals

Mapping them to garments via FlipWear
Add FINAOs and link them to a specific interest Tile
Select whether your FINAO is On Track, Behind or Ahead of schedule
Add photos or videos that support any of your FINAOs
Keep a journal of activity to record your progress toward achieving your FINAOs.
Choose to make public any of your tiles and FINAO activity

### Archive any FINAOs

Publish your Portfolio Accomplishments to a Resume you can share
Add or change your background photo to your “Share It” Profile Page
Chose to track others who inspire your FINAOs
Check your messages
Review your Resources—these are sponsors products selected by FINAO that can help you achieve your FINAO. These are specific to each tile.
See who is tracking you
See who you are tracking
Review and manage your TagNotes™
Update your connection to your Team Connects
Invite a Mentor to help you achieve your FINAOs
View the Profiles of other members you are tracking
View your Mentors
Profile “SHARE IT” page.

A personal Profile becomes a public “SHARE IT” page. Here you share your selected FINAO activity in a controlled manner. Within the FINAOs you select to make public in SHARE IT you will be showing:

The tiles the FINAO is linked
All public FINAOs within the shared Tile
Show whether your FINAO is On Track, Behind or Ahead of schedule
Show all photos or videos that support each shared FINAOs
Show Activity Journal of your progress toward achieving your FINAOs
The status of the Tile activity (average of all FINAOs within the Tile)
Display your selected background photo

### Your Team Connects

A Dashboard view of your Profile Stats

Note: With any FINAO you have selected to make public, you can choose to make private with one button click within your LIVE IT page.

### Tiles.

A tile is one of the different interests you can select to help keep your FINAOs organized and on track. When you create a FINAO, select a tile that becomes the grouping bucket for these related interests you have. Each Tile can include multiple unique FINAOs, photos, videos, stats, goals and tracking Once selected and populated, you can chose to make any tile public or at any time make it private again. Once public, the tiles can be viewed on the Profile page.

### FINAO.

A FINAO is your statement of what you want to achieve. Your FINAOs can be as short-term as “I will rush for 100 yards on Saturday night” to as long-term as “I will reach the summit of all major peaks in North America to as personal as “I will spend more quality time with my children in 2013”.

Your FINAO is what you establish to aspire to. It needs to align with your passions and capabilities, not those expected of you by society.

### Using a Mentor.

Reaching out to other members that can help you achieve your goals is the where the Mentor comes in. A Mentor has access to your LIVE IT portfolio only by your invitation. Your Mentor (s) will have access only to Tiles you invite them. The Mentor is restricted at the Tile level but will have access to all private and public FINAOs within that tile. Here they can follow and comment on your goals, journals, activities and tracking sheets. Mentors can comment and interact with the Member.

An example of a Mentor might be a Coach, Counselor, Instructor, Senior Teammate or Personal Trainer.

Tracking Someone or Letting them Track Me.

Whenever you are viewing another members SHARE IT page, there is a “Track” button at the top of their workspace. To track their FINAOs and progress, click the “Track” button. This will send a message to them to accept your request to track them. They can accept or deny the request.

When a member viewing your SHARE IT page, clicks on the “Track Me” button, you will be sent a request message to allow them to track you. You can accept or deny the request.

Why can't I comment on a FINAO of someone I am tracking?

The FINAO Nation is built on creating a platform for drama-free social media. Where anyone can establish their goals and put their FINAO out to world as declaration of—“I will not fail, that is not an option”. By making this public, it is not our place to pass judgment upon another's goals or efforts.

If you want to show support of someone's FINAO, view their videos, photos and journals. This will show activity to them. If you disapprove or dislike their efforts, simply choose to quit tracking them.

### A Team Portfolio.

Teams, ranging from High School sports to bowling leagues to Little League Soccer may create a Team Portfolio Page with the purpose of managing the team's online activity. This is only available for actual teams and must be approved by the FINAO Nation content managers. Submit this form to set up your Team Page.

The Coach/Manager will create the page and manage the content. Within each Team Page, there are multiple Tiles the Manager can select to make public. These include:

### Team Schedule

### Team Roster

Team stats

### Coaches Journal

### Team FINAOs

Booster support

### League Information

Team FlipWear choices
In addition to the web page, the team can create a team-branded FlipWear product for team members and supporters.

With regard to systems and components above referred to, but not otherwise specified or described in detail herein, the workings and specifications of such systems and components and the manner in which they may be made or assembled or used, both cooperatively with each other and with the other elements disclosed herein to effect the purposes herein disclosed, are all believed to be well within the knowledge of those skilled in the art. No concerted attempt to repeat here what is generally known to the artisan has therefore been made.

### INDUSTRIAL APPLICABILITY

Application of the disclosed subject matter to the needs recognized and summarized above is especially beneficial in that the disclosed systems, methods and articles are the only ones that effectively provide practical, affordable and readily available solutions to these needs.

The subject matter disclosed herein provides unique industrial applicability in that it uniquely provides an article with a hidden message display in which the mechanism for revealing or sharing the message is not obvious to a viewer (who is not the wearer), and in which the wearer can selectively control the visibility of the display to others, thereby enabling the wearer to choose the audience (and the time and place) for the hidden display to be revealed.

It also uniquely provides a method to activate each such hidden message in infinitely variable ways, from startling and overt, to furtive and fleeting, to casual or subtle, and thus selectively to startle viewers with elements of surprise and excitement, to tease and intrigue viewers, or to simply inspire, delight and communicate.

It also provides an online social networking forum for inspiration that leads and pulls for personal best, on one's own terms, and according to one's own rules; a place that relates to sports, business, relationships, athletics, and life in general.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A system for creating and ordering a novel personal inspirational message storage article, selectively displaying or sharing the message, and networking with others about stored and shared inspirational messages, the system comprising:
a customer computer connected to a company computer through a global network for a customer to select, order and pay for, via order control, message processing and check out modules operably connected with the company computer, a message storage article and to select or create a personal inspirational message for the article, the message processing and check out modules further operably connected to an article manufacturing and shipment system computer;
the order control module operatively residing in computer readable memory operatively connected to the company computer for receiving an order of the article from the customer;
the message processing module operatively residing in computer readable memory operatively connected to the company computer for selectably creating by the customer, or selecting by the customer from among inspirational messages previously stored in operably connected databases, the personal inspirational message, and storing the selected personal inspirational message as a message data file containing character information and or image information;
the check out cart module operatively residing in computer readable memory operatively connected to the company computer for handling payment for and shipping of the ordered article;
the article manufacturing system computer operably connected with the message processing module for transferring the message data file to an image transfer module operatively residing in computer readable memory operably connected with the article manufacturing system computer for controlling transfer of the message to a selected area of the article, thus customizing the article with the selected message, the selected area of the article to which the message is transferred being on the inner side of a flexible material of which the article is made;
the shipping being ordered through the check out module by the customer and executed by the shipping system upon completion of the article by the article manufacturing system;
wherein the customer receives the hidden message article ordered and selectively displays or shares the hidden personal inspirational message with others wearing the article and then selectably shifting the article by lifting, twitching, raising or folding or otherwise altering the wear or drape of the article to a manually sustained message sharing mode so that the message is displayed to and shared with a second person, but only while the first person sustains action to shift, lift, twitch, raise or fold or otherwise alter the wear or drape of the article into the message sharing mode; and
the system further comprising a customer computer connected for communication through the global network for a customer to enter a community portal page on a website operatively residing on the computer readable memory of a company computer connected with the global network, on which page the customer can blog with other customers about the customer's use of her shared inspirational messages or her observed use of the inspirational messages of others, link to conventional social media, search for other customers by name or message, or review other customers' personal inspirational messages or information about the use or sharing of those messages.

2. An article configurable to be worn by a first person, the article comprising:
a. a flexible material having an inner side facing the first person when the article is being worn, and an outer side facing away from the first person when the article is being worn, where the material is not a flap connected to the article and not a fold in the article;
b. a message that is disposed on the inner side of the material, facing the first person;
c. the message comprising any combination of alphanumerical characters and or other graphical elements, such as pictures or drawings;
d. two alternate wear modes selectable by the first person: a message sharing mode, and a message secret mode;
wherein the article is selectably switchable to the message sharing mode so that the message is readily viewable by a second person, but only while the first person sustains action to shift, lift, twitch, raise or fold or otherwise alter the wear or drape of the article into the message sharing mode.

3. The article of claim 2 wherein the flexible material is a single layer of material.

4. The article of claim 2 wherein the article reverts to message secret mode and the message is not otherwise visible to the second person whenever the first person is not taking or sustaining action to shift, lift, twitch, raise or fold or otherwise alter the wear or drape of the article into the message sharing mode.

5. The article of claim 2 wherein the article is selected from the group of articles consisting of t-shirt, sweat shirt, polo shirt, jacket, sweater, and other upper torso covering attire or garments.

6. The article of claim 2 wherein the message is disposed on the article by being imprinted screened or stitched directly onto the inner side of the material.

7. The article of claim 2 wherein the message is disposed on the article as an add-on piece or patch by being connected to the inner side of the material, either removably or permanently.

8. The article of claim 7 wherein the message is stitched or printed onto a patch, and the patch is either glued or sewn to the material.

9. The article of claim 7 wherein the message is stitched or printed onto a patch, and the patch is removably connected to the material with a removable fastener such as hook-and-loop, snaps, buttons, magnets or the like.

10. The article of claim 2 wherein the message is disposed on an edge or hem or waistband of the article.

11. The article of claim 2 further comprising a machine readable data tag, such as an RFID chip or a bar code, wherein the data tag may be separate from or integrated into the message.
